(19) United States
(12) Patent Application Publication
(10) Pub. No.: US 2016/0227052 A1
(43) Pub. Date: Aug. 4, 2016

(54) IMAGE DATA TRANSMISSION DEVICE, IMAGE DATA RECEPTION DEVICE, AND IMAGE DATA TRANSMISSION AND RECEPTION METHOD

(71) Applicant: Hiroshi HOSAKA, Tokyo (JP)

(72) Inventor: Hiroshi HOSAKA, Tokyo (JP)

(73) Assignee: Ricoh Company, Limited, Tokyo (JP)

(21) Appl. No.: 15/007,656

(22) Filed: Jan. 27, 2016

(30) Foreign Application Priority Data
Feb. 4, 2015 (JP) 2015-020496
May 11, 2015 (JP) 2015-096827

(51) Int. Cl. H04N 1/00; G06F 3/12

(52) U.S. Cl. CPC H04N 1/00238; H04N 1/00129; H04N 1/00251; G06F 3/1208; G06F 3/1236; G06F 3/1271; G06F 3/1293

(57) ABSTRACT

An image data transmission device includes a first generation unit, a distribution unit, a first reception unit, a second generation unit, and a first transmission unit. The first generation unit generates, from first moving image data, second moving image data to be distributed. The distribution unit distributes the second moving image data generated by the first generation unit to an external device. The first reception unit receives an acquisition request for still image data from the external device, with respect to the second moving image data being distributed by the distribution unit. The second generation unit generates still image data from the first moving image data according to the acquisition request. The first transmission unit transmits the still image data generated by the second generation unit to the external device as a response to the acquisition request.

### CROSS-REFERENCE TO RELATED APPLICATIONS

The present application claims priority to and incorporates by reference the entire contents of Japanese Patent Application No. 2015-020496 filed in Japan on Feb. 4, 2015 and Japanese Patent Application No. 2015-096827 filed in Japan on May 11, 2015.

### BACKGROUND OF THE INVENTION

1. Field of the Invention

The present invention relates to an image data transmission device, an image data reception device, and an image data transmission and reception method.

2. Description of the Related Art

Conventionally, moving image data has been distributed via a communication network such as the Internet. In recent years, various devices such as a personal computer (PC), an image forming apparatus, and a mobile terminal have an image pickup function and a communication function. Electronic conferences (video conferences) and the like have been held by mutually transmitting and receiving moving image data picked up by these devices.

The reception side device that receives the distributed moving image data can view the moving image data. However, there may be a situation when one scene (image) in the moving image data is to be acquired as a still image. For example, still image data needs to be acquired when one scene in the moving image data is to be printed, or to be stored as a still image. In such a case, in the conventional technology, still image data is cut out from the distributed moving image data in the reception side device, and printing, saving, and the like are performed by using the still image data.

However, from the viewpoint of reducing traffic capacity and preventing delay, the moving image data to be distributed is generally moving image data having a small data quantity, obtained by reducing the resolution and the like of the moving image data picked up by the image pickup device. Thus, when still image data is acquired using the conventional method described above, there is a possibility that the image quality thereof becomes lower than the original image quality picked up by the image pickup device.

Therefore, there is a need for an image data transmission device, an image data reception device, and an image data transmission and reception method capable of acquiring still image data having a higher image quality, from the moving image data being distributed.

### SUMMARY OF THE INVENTION

It is an object of the present invention to at least partially solve the problems in the conventional technology.

According to an embodiment, an image data transmission device includes a first generation unit, a distribution unit, a first reception unit, a second generation unit, and a first transmission unit. The first generation unit generates, from first moving image data, second moving image data to be distributed. The distribution unit distributes the second moving image data generated by the first generation unit to an external device. The first reception unit receives an acquisition request for still image data from the external device, with respect to the second moving image data being distributed by the distribution unit. The second generation unit generates still image data from the first moving image data according to the acquisition request. The first transmission unit transmits the still image data generated by the second generation unit to the external device as a response to the acquisition request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration example of an image data transmission and reception system according to a first embodiment;

FIG. 2 is a diagram illustrating an example of an external configuration of an image forming apparatus;

FIG. 3 is a diagram illustrating another example of the external configuration of the image forming apparatus;

FIG. 4 is a diagram illustrating still another example of the external configuration of the image forming apparatus;

FIG. 5 is a block diagram illustrating an example of a hardware configuration of the image forming apparatus according to the first embodiment;

FIG. 6 is a block diagram illustrating an example of a functional configuration of the image forming apparatus according to the first embodiment;

FIG. 7 is a diagram illustrating an example of an initial screen;

FIG. 8 is a diagram illustrating an example of a camera image screen;

FIG. 9 is a diagram illustrating an example of a relation between a camera and a document platen;

FIG. 10 is a diagram illustrating an example of a guide image;

FIG. 11 is a diagram illustrating another example of the guide image;

FIG. 12 is a diagram illustrating an example of a focus position specification screen;

FIG. 13 is a diagram illustrating an example of a copy screen;

FIG. 14 is a schematic diagram illustrating an example of a data configuration of a focus position setting table;

FIG. 15 is a flowchart illustrating an example of a procedure of an operation receiving process;

FIG. 16 is a flowchart illustrating an example of a procedure of a focus position setting process;

FIG. 17 is a flowchart illustrating an example of a procedure of a document size changing process;

FIG. 18 is a diagram illustrating an example of a conference screen;

FIG. 19 is a diagram illustrating an example of a print mode screen;

FIG. 20 is a diagram illustrating an example of an accumulation mode screen;

FIG. 21 is a diagram illustrating an example of an image quality setting mode screen;

FIG. 22 is a schematic diagram illustrating an example of data transfer according to the exchange of still image data;

FIG. 23 is a schematic diagram illustrating another example of the data transfer according to the exchange of still image data;

FIG. 24 is a diagram illustrating an example when errors are displayed;

FIG. 25 is a flowchart illustrating an example of a procedure of a still image data acquiring process;

FIG. 26 is a flowchart illustrating an example of a procedure of a still image data providing process;

FIG. 27 is a block diagram illustrating an example of a hardware configuration of an image forming apparatus according to a second embodiment;

FIG. 28 is a diagram illustrating an example of an application setting screen;

FIG. 29 is a schematic diagram illustrating an example of a data configuration of application setting information;

FIG. 30 is a flowchart illustrating an example of a procedure of an application setting process; and

FIG. 31 is a flowchart illustrating an example of a procedure of an application startup process.

### DETAILED DESCRIPTION OF THE PREFERRED EMBODIMENTS

Preferred embodiments according to the present invention will be described in detail below with reference to the accompanying drawings. In the present embodiments, a reception device and a transmission device according to the present invention are applied to an image forming apparatus. However, the apparatuses to which the reception device and the transmission device according to the present invention can be applied are not limited thereto. In the embodiments described below, image data is a concept including moving image data and still image data. If the moving image data and the still image data need not to be distinguished from each other, they are simply referred to as image data.

### First Embodiment

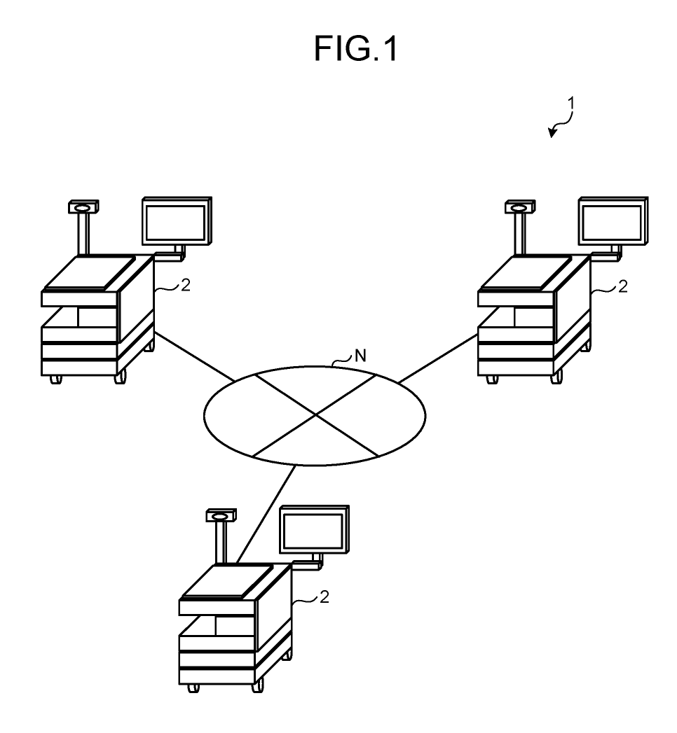

FIG. 1 is a diagram illustrating a configuration example of an image data transmission and reception system 1 according to the first embodiment. As illustrated in FIG. 1, the image data transmission and reception system 1 has a plurality of image forming apparatuses 2. Each of the image forming apparatuses 2 is connected to a network N such as a local area network (LAN) or the Internet, and configured to be communicable with each other. The number of the image forming apparatus 2 connected to the network N is optional.

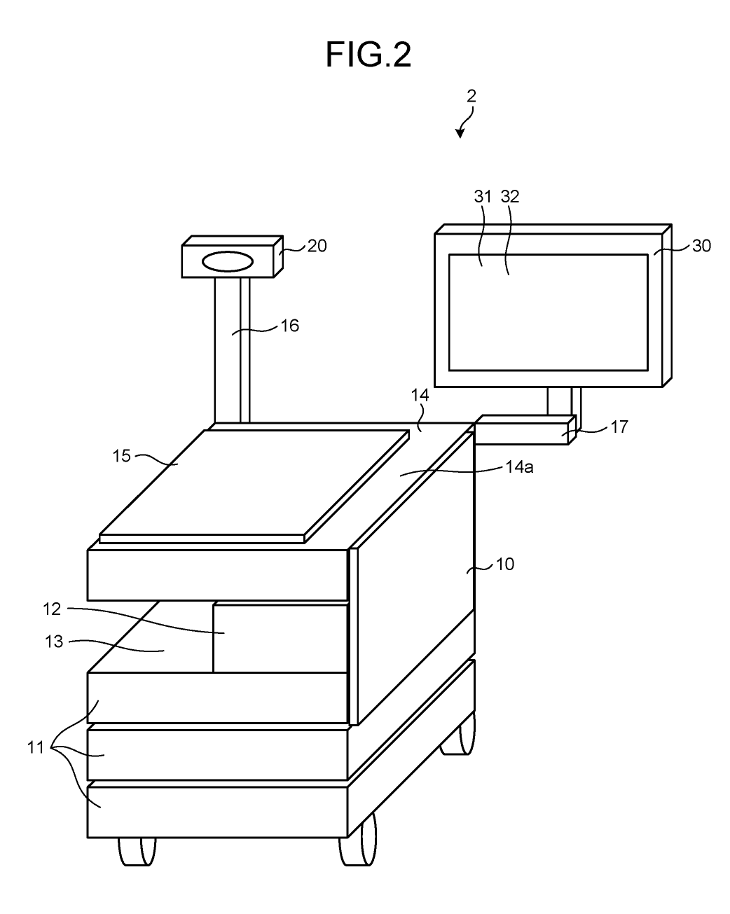

FIG. 2 is a diagram illustrating an example of an external configuration of the image forming apparatus 2. As illustrated in FIG. 2, the image forming apparatus 2 includes a main body unit 10, a camera unit 20, and an operation unit 30. The main body unit 10 has a paper feeding unit 11 that supplies a transfer sheet, and a printing unit 12 that forms an image on the transfer sheet fed from the paper feeding unit 11. When the image is formed on the transfer sheet, the printing unit 12 ejects the transfer sheet onto a paper ejection table 13 provided in the middle of the main body unit 10 via a paper ejection port, which is not illustrated. In the configuration of FIG. 2, there are three paper feeding units 11. However, the number of the paper feeding unit 11 is not limited thereto. A method of feeding paper by the paper feeding unit 11 and a method of forming an image by the printing unit 12 are optional, and known techniques such as an electrophotography method and an inkjet method may be used.

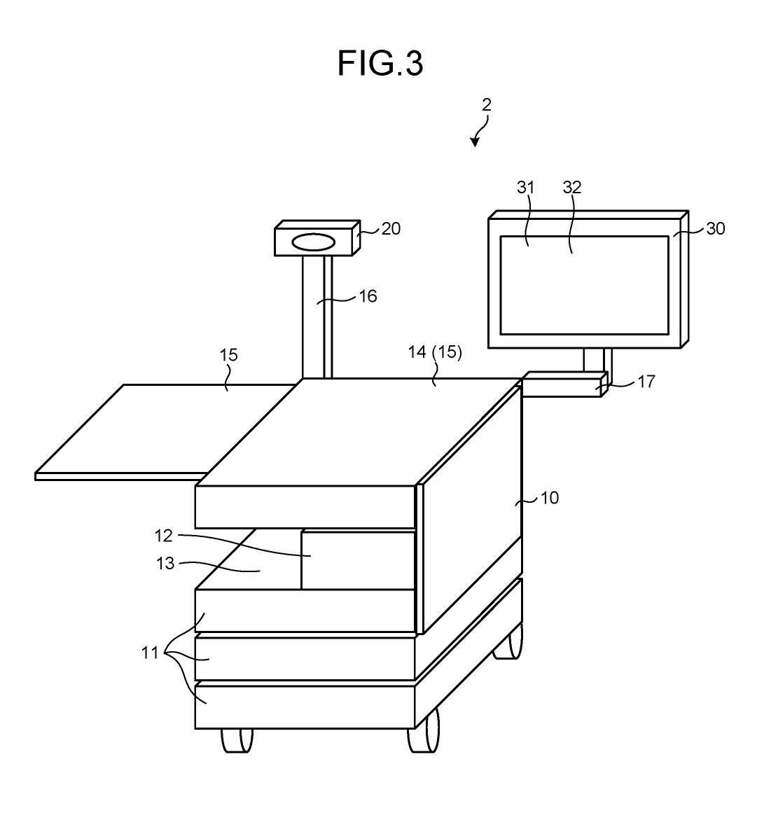

A document platen 15 is provided on an upper surface 14 of the main body unit 10. A document or an object the image of which is to be picked up by the camera unit 20 is placed on the document platen 15. The shape and configuration of the document platen 15 is not limited to the example in FIG. 2. For example, as illustrated in FIG. 3, the document platen 15 may be connected to the upper surface 14 of the main body unit 10 using a hinge, a slide mechanism, and the like, thereby extending the area of the document platen 15.

FIG. 3 is a diagram illustrating another example of the external configuration of the image forming apparatus 2. In FIG. 3, the right edge of the document platen 15 is connected to the left edge of the upper surface 14 by a hinge, and the document platen 15 is opened using the left edge of the upper surface 14 as a fulcrum. Here, it is preferable that the upper surface 14 and the document platen 15 are connected so that the surface thereof becomes flat. In this case, the area of a flat surface formed by the upper surface 14 and the document platen 15 is larger than that in FIG. 2. Hence, by using the whole flat surface formed by the upper surface 14 and the document platen 15 as the document platen 15, it is possible to extend the area of the document platen 15.

The color and material of the surface of the document platen 15 (upper surface 14) are optional. For example, by adhering a synthetic resin sheet and the like onto the surface of the document platen 15, it may be used as a whiteboard so that the user can draw images and write words on its surface, or erase the images and words thereon.

The camera unit 20 is mounted on a support post 16 that stands on the main body unit 10. The camera unit 20 includes an image sensor such as a charge-coupled device (CCD) and a complementary metal oxide semiconductor (CMOS), and picks up images of various objects. It is preferable that the camera unit 20 has a contrast AF (autofocus) function.

The image pickup direction of the camera unit 20 is changeable in the panning direction (horizontal direction) and in the tilting direction (vertical direction), by a driving mechanism, which is not illustrated, provided on the support post 16. For example, when the image pickup direction is directed toward the document platen 15, the camera unit 20 picks up an image of an article placed on the document platen 15 or a word and the like written on the document platen 15. When the image pickup direction is directed toward the front of the main body unit 10 (front side of the diagram), the camera unit 20 picks up an image of a user and the like positioned in front of the main body unit 10.

In the main body unit 10, the position of the support post 16 is optional. However, it is preferable that the support post 16 is provided at the position where the camera unit 20 can pick up the image of the entire surface of the document platen 15. It is also possible to configure the support post 16 to be telescopic, so that the camera unit 20 may be movable in the vertical direction.

The operation unit 30 is mounted on a support post 17 extended from the main body unit 10. The operation unit 30 includes a display device 31 such as a liquid crystal display (LCD) and a touch panel 32 provided on the display surface of the display device 31.

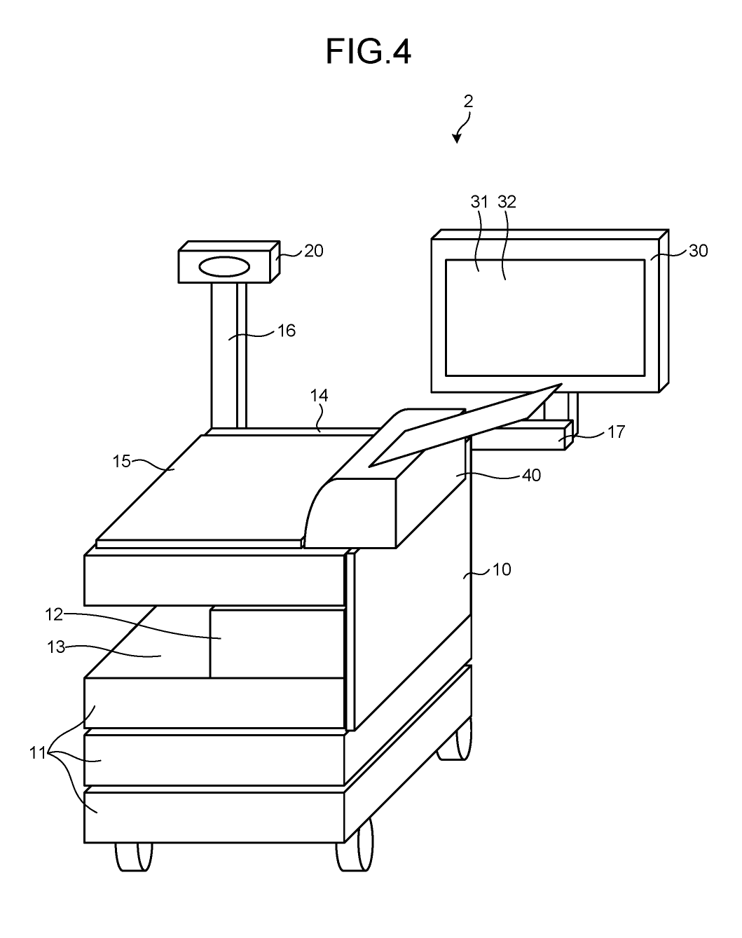

The device configuration of the image forming apparatus 2 is not limited to those in FIG. 2 and FIG. 3. For example, as illustrated in FIG. 4, the image forming apparatus 2 may include a scanner unit 40 such as a sheet feed scanner. Here, FIG. 4 is a diagram illustrating still another example of the external configuration of the image forming apparatus 2. In FIG. 4, the scanner unit 40 is provided on a space portion 14a on the upper surface 14 illustrated in FIG. 2. The paper ejection direction of the scanner unit 40 is optional, and the paper may be ejected in the direction toward the document platen 15 or in the downward direction (rightward direction of the main body unit 10).

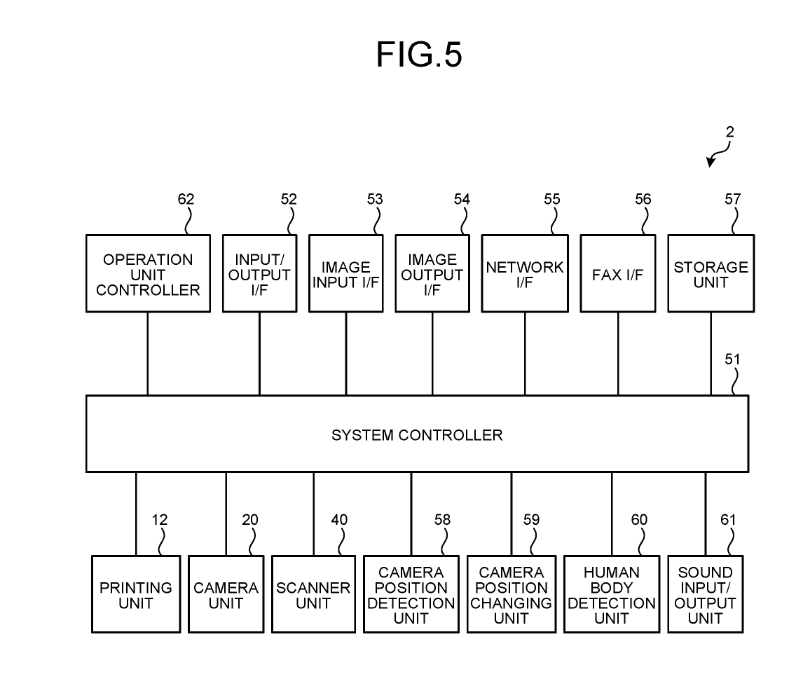

An internal configuration of the image forming apparatus 2 will now be described. FIG. 5 is a block diagram illustrating an example of a hardware configuration of the image forming apparatus 2. As illustrated in FIG. 5, the image forming apparatus 2 includes a system controller 51. The system controller 51 has a computer configuration including a central processing unit (CPU), a System-on-a-Chip (SoC), read-only memory (ROM), random-access memory (RAM), and the like. The system controller 51 integrally controls the operation of the image forming apparatus 2. More specifically, the system controller 51 causes its own device to operate as an image data transmission device, by functioning as a first generation unit, a distribution unit, a first reception unit, a second generation unit, and a first transmission unit. The system controller 51 also causes its own device to operate as an image data reception device, by functioning as a second reception unit, a display controlling unit, a receiving unit, a second transmission unit, and a third reception unit.

Various interfaces such as an input/output interface (I/F) 52, an image input I/F 53, an image output I/F 54, a network I/F 55, and a fax I/F 56 are connected to the system controller 51.

The input/output I/F 52 is a general input/output interface that meets a predetermined standard such as a universal serial bus (USB). The image input I/F 53 is an interface for inputting an image (video) signal. For example, the image input I/F 53 is connected to the camera unit 20 and the scanner unit 40, which will be described below. The image output I/F 54 is an interface for outputting an image (video) signal. For example, the image output I/F 54 is connected to the display device 31 of the operation unit 30. The network I/F 55 is a network interface connectable to the network N. The fax I/F 56 is a fax model and a network interface that meets a data communication standard such as the EIA-592.

A storage unit 57 is connected to the system controller 51. The storage unit 57 is a storage device such as a hard disk drive (HDD) and a solid-state drive (SSD). The storage unit 57 stores therein various programs such as an operating system, various programs (applications) for implementing various functions, which will be described below, and various types of data.

A camera position detection unit 58, a camera position changing unit 59, a human body detection unit 60, a sound input/output unit 61, and the like are also connected to the system controller 51, in addition to the printing unit 12, the camera unit 20, and the scanner unit 40 described above. The camera position detection unit 58 and the camera position changing unit 59 configure a driving mechanism at the support post 16 described above.

For example, the camera position detection unit 58 is a gyro sensor, and detects the orientation (image pickup direction) of the camera unit 20. The camera position changing unit 59 includes a monitor and the like, which are not illustrated, and moves the image pickup direction of the camera unit 20 in the panning direction (horizontal direction) and in the tilting direction (vertical direction). The image pickup direction of the camera unit 20 is not limited to the horizontal direction or the vertical direction, but it may also be the front direction or the rear direction. A method for detecting the image pickup direction of the camera unit 20 is optional, and for example, known techniques such as an encoder pulse may be used for detection. The image pickup direction of the camera unit 20 may be automatically changed by the camera position changing unit 59, according to the control of the system controller 51, or the user can change it manually. The human body detection unit 60 is a human body detection sensor such as an infrared ray sensor, and detects when the user comes close to the image forming apparatus 2. The sound input/output unit 61 includes a sound collection device such as a microphone and a sound output device such as a speaker, and performs input and output of sound data.

An operation unit controller 62 is also connected to the system controller 51. The operation unit controller 62 has a computer configuration including the CPU, the SoC, the ROM, the RAM, and the like, and receives a display control of the display device 31 and an input of a user operation via the touch panel 32, by collaborating with the system controller 51.

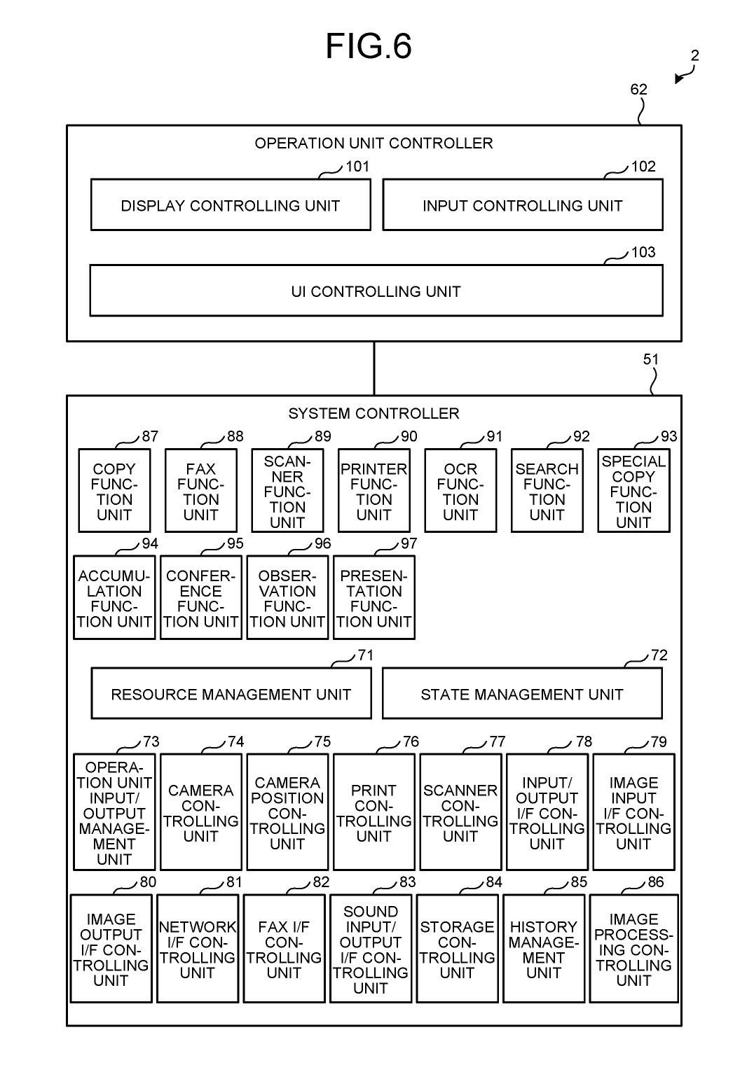

FIG. 6 is a block diagram illustrating an example of a functional configuration of the image forming apparatus 2. As illustrated in FIG. 6, the system controller 51 includes various management units, controlling units, and the like. The management units and the controlling units such as these are implemented in a software manner by executing the programs stored in the storage unit 57, or implemented in a hardware manner by a dedicated processor in the system controller 51.

A resource management unit 71 manages resources commonly used by applications such as the printing unit 12, the camera unit 20, and the scanner unit 40. A state management unit 72 manages the state of its own device (image forming apparatus 2). For example, the state management unit 72 monitors the states of the paper feeding unit 11 and the printing unit 12, and the state of each application. When an inactive state continues for a predetermined time, the state management unit 72 switches to an energy saving operation such as a standby mode.

An operation unit input/output management unit 73 is a function unit that manages the coordination with the operation unit controller 62. For example, the operation unit input/output management unit 73 outputs image data and the like to the operation unit 30, and also receives an input of operational data indicating the operation contents of the operation unit 30.

A camera controlling unit 74 performs various controls according to the image pickup of the camera unit 20 such as a focus control of the camera unit 20 and controlling an image sensor. A camera position controlling unit 75 changes the image pickup direction of the camera unit 20, by driving the camera position changing unit 59 based on the detection results obtained by the camera position detection unit 58. For example, when a copy button B116, which will be described below, is operated, the camera position controlling unit 75 drives the camera position changing unit 59 so that the image pickup direction of the camera unit 20 is directed toward the document platen 15. When a conference button B124, which will be described below, is operated, the camera position controlling unit 75 drives the camera position changing unit 59 so that the image pickup direction of the camera unit 20 is directed toward the front direction of the main body unit 10.

A print controlling unit 76 prints an image and the like on a transfer sheet by controlling the paper feeding unit 11 and the printing unit 12. A scanner controlling unit 77 causes the scanner unit 40 to perform a scanning operation, by controlling the scanner unit 40.

An input/output I/F controlling unit 78 controls the input and output of data to and from an external device connected to the input/output I/F 52, by collaborating with the input/output I/F 52. An image input I/F controlling unit 79 controls an input of image data via the image input I/F 53, by collaborating with the image input I/F 53. An image output I/F controlling unit 80 controls an output of image data via the image output I/F 54, by collaborating with the image output I/F 54. A network I/F controlling unit 81 controls data communication with an external device (other image forming apparatus 2) connected to the network N, by collaborating with the network I/F 55. A fax I/F controlling unit 82 controls data communication with an external device connected to a fax line, by collaborating with the fax I/F 56. A sound input/output I/F controlling unit 83 controls the input and output of sound data, by collaborating with the sound input/output unit 61.

A storage controlling unit 84 controls writing (storing) of various types of data to a storage device such as the storage unit 57, and reading of various types of data from the storage device. A history management unit 85 records the history of a user operation performed via the operation unit 30, the history of changing state of its own device, and the like.

An image processing controlling unit 86 performs various types of image processing such as a resolution conversion on image data input from the camera unit 20, the scanner unit 40, and the like. The image processing controlling unit 86 also performs various types of image processing such as a resolution conversion on image data stored in the RAM, the storage unit 57, and the like.

The system controller 51 has various types of function units, by executing various applications stored in the storage unit 57. These function units implement a predetermined function according to an application, by collaborating with various management units and controlling units described above.

A copy function unit 87 implements a copy function of printing image data input from the camera unit 20, the scanner unit 40, and the like onto a transfer sheet. A fax function unit 88 implements a fax function of transmitting image data input from the camera unit 20, the scanner unit 40, and the like to an external device connected to a fax line. A scanner function unit 89 implements a scanner function of saving image data input from the camera unit 20, the scanner unit 40, and the like to an external device connected to the storage unit 57 and the input/output I/F 52. A printer function unit 90 implements a printer function of printing image data input from the camera unit 20 and the like onto a transfer sheet. An optical character reader (OCR) function unit 91 implements an OCR function of identifying a character string included in image data input from the camera unit 20, the scanner unit 40, and the like, and converts it into character data.

A search function unit 92 implements a search function of searching data that corresponds to the condition of a search key input via the operation unit 30 and the like, from various types of data saved in the storage unit 57 and the like. A special copy function unit 93 implements a special copy function of printing image data input from the camera unit 20, the scanner unit 40, and the like by enlarging or reducing its size, or the like. An accumulation function unit 94 implements an accumulation function of accumulating (saving) image data and the like transmitted from an external device (other image forming apparatus 2) into the storage device such as the storage unit 57.

A conference function unit 95 implements a video conference function of conducting a video conference with the other image forming apparatus 2. An observation function unit 96 implements an observation function of observing (for example, fixed point observation) an object using the camera unit 20. A presentation function unit 97 implements a presentation function of transmitting image data picked up by the camera unit 20, to the other image forming apparatus 2 connected to the network N.

The operation unit controller 62 includes a display controlling unit 101, an input controlling unit 102, and a user interface (UI) controlling unit 103. The controlling units such as these are implemented in a software manner by executing the programs stored in the ROM and the like of the operation unit controller 62, or implemented in a hardware manner by a dedicated processor in the operation unit controller 62.

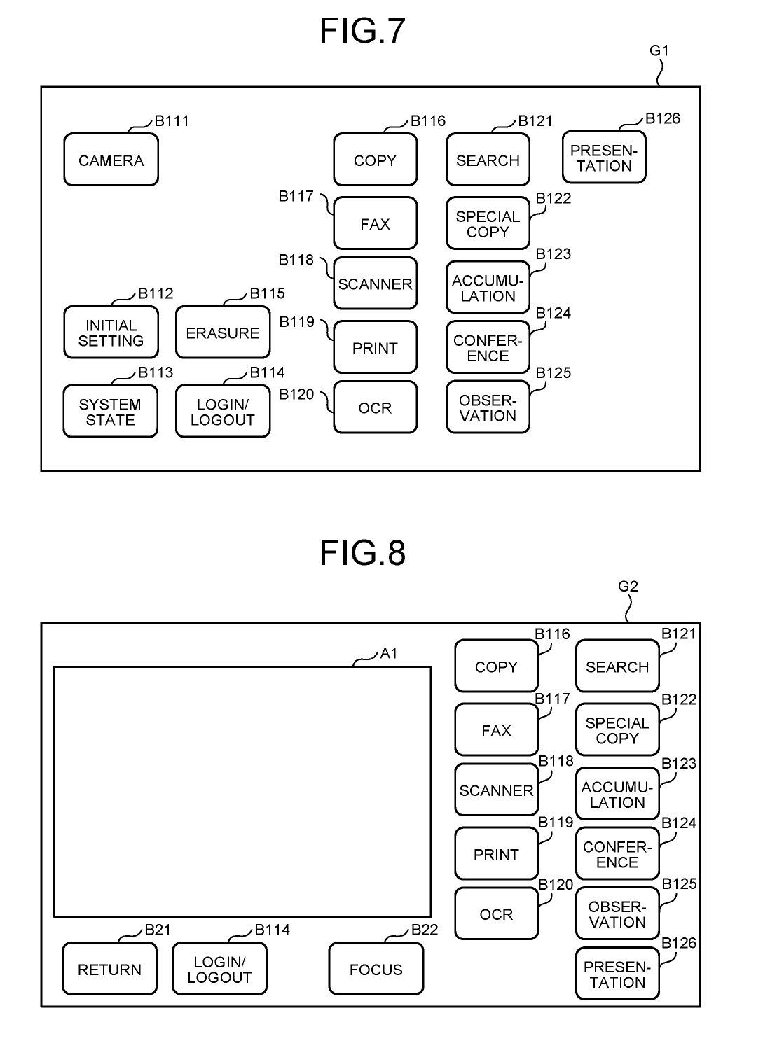

The display controlling unit 101 controls the display of the display device 31. The input controlling unit 102 converts the physical user operation (input) on the touch panel 32 to a logical input indicating the operation content. The UI controlling unit 103 displays various UIs according to the operation of the image forming apparatus 2 on the display device 31, by collaborating with the display controlling unit 101. For example, the UI controlling unit 103 displays an initial screen illustrated in FIG. 7 on the display device 31, as a home screen according to the operation of the image forming apparatus 2.

Here, FIG. 7 is a diagram illustrating an example of an initial screen displayed on the display device 31 of the operation unit 30. As illustrated in FIG. 7, an initial screen G1 has various operating elements according to the operations of the image forming apparatus 2. For example, a camera button B111 is an operating element for activating the camera unit 20. An initial setting button B112 is an operating element for changing the setting of the image forming apparatus 2. A system state button B113 is an operating element for displaying the states such as the remaining amount of toner and the accumulation state of image data. A login/logout button B114 is an operating element for identifying the user. An erasure button B115 is an operating element for erasing data stored temporarily.

The initial screen G1 also has operating elements (buttons) for activating various applications (function units). For example, the copy button B116 is an operating element for activating the copy function (copy function unit 87). A fax button B117 is an operating element for activating the fax function (fax function unit 88). A scanner button B118 is an operating element for activating the scanner function (scanner function unit 89). A printer button B119 is an operating element for activating the printer function (printer function unit 90). An OCR button B120 is an operating element for activating the OCR function (OCR function unit 91). A search button B121 is an operating element for activating the search function (search function unit 92). A special copy button B122 is an operating element for activating a special copy function (special copy function unit 93). An accumulation button B123 is an operating element for activating the accumulation function (accumulation function unit 94). A conference button B124 is an operating element for activating the conference function (conference function unit 95). An observation button B125 is an operating element for activating the observation function (observation function unit 96). A presentation button B126 is an operating element for activating the presentation function (presentation function unit 97).

When an operating element on the initial screen G1 is operated, the UI controlling unit 103 displays a UI corresponding to the operating element. The UIs other than the initial screen GI displayed by the UI controlling unit 103 will be described below.

Hereinafter, characteristic operations of the image forming apparatus 2 will be described. An operation according to the control of the focus position of the camera unit 20 will now be described, as the first characteristic of the image forming apparatus 2.

Upon receiving an operation of the camera button B111 on the initial screen G1 described above, the system controller 51 starts to pick up an image, by operating the camera unit 20. The system controller 51 also displays a camera image screen illustrated in FIG. 8 on the display device 31, by collaborating with the UI controlling unit 103.

FIG. 8 is a diagram illustrating an example of a camera image screen. As illustrated in FIG. 8, a camera image screen G2 has a return button B21 and a focus button B22, in addition to the login/logout button B114 and the buttons B116 to B126 described above. Here, the return button B21 is an operating element for returning to the initial screen G1. The focus button B22 is an operating element for setting the focus position of the camera unit 20. The camera image screen G2 also has an area A1, where image data picked up by the camera unit 20 is displayed as a picked up image.

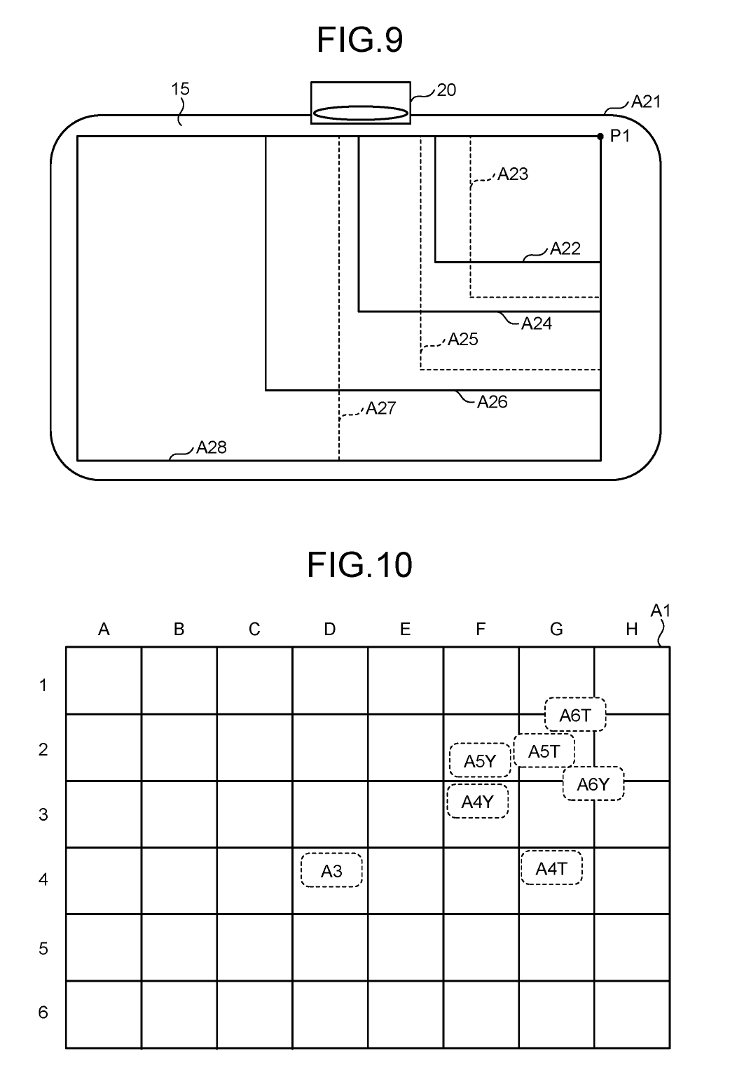

Here, FIG. 9 is a diagram illustrating an example of a relation between the camera unit 20 and the document platen 15. In FIG. 9, as illustrated in FIG. 3, the document platen 15 is in an open state. An area A21 is an image pickup range of the camera unit 20. An area A22 is a range of a document size A6Y, and an area A23 is a range of a document size A6T (Y is a landscape orientation and T is a portrait orientation). An area A24 is a range of a document size A5Y, and an area A25 is a range of a document size A5T. An area A26 is a range of a document size A4Y, an area A27 is a range of a document size A4T, and an area A28 is a range of a document size A3. The standard position to place a document on the document platen 15 is at a point P1 at the upper right hand side in FIG. 9.

For example, when a document having the document size A6Y is placed on the document platen 15, if the focus position of the camera unit 20 is set at the position appropriate for the document size A3 (approximately in the center of the area A28), there is a possibility that the picked up image of the document may be unclear. Thus, in the image forming apparatus 2, the focus position of the camera unit 20 can be changed to any position.

More specifically, when the focus button B22 illustrated in FIG. 8 is operated, the system controller 51 shifts to an operation mode for specifying a focus position, by collaborating with the camera controlling unit 74. Under this operation mode, for example, the system controller 51 displays a guide image that supports specifying the focus position on the area A1.

FIG. 10 is a diagram illustrating an example of a guide image. For example, the guide image is transparently displayed on the picked up image in the area A1. FIG. 10 illustrates a grid pattern that divides the area A1, in other words, the image pickup range (area A21) of the camera unit 20 into small areas. The operating elements (areas surrounded by a dotted line) are arranged at the focus position corresponding to each of the areas A22 to A28. The reference numerals and characters (A to H and 1 to 6) at the periphery of the guide image are coordinates for indicating the small areas. The system controller 51 displays the focus position currently being set in a superimposed manner, on the picked up image in the area A1.

When the guide image of FIG. 10 is used, the user of the image forming apparatus 2 can indicate the focus position of the camera unit 20, by selectively operating the operating element displayed on the area A1. For example, upon receiving an operation of the operating element “A6T”, the input controlling unit 102 notifies the system controller 51 of the coordinates (G, 2) corresponding to the position of the operating element. The system controller 51 then sets the focus position of the camera unit 20 to the position corresponding to the coordinates (G, 2), by collaborating with the camera controlling unit 74. The changing method of the focus position is optional, and known techniques may be used.

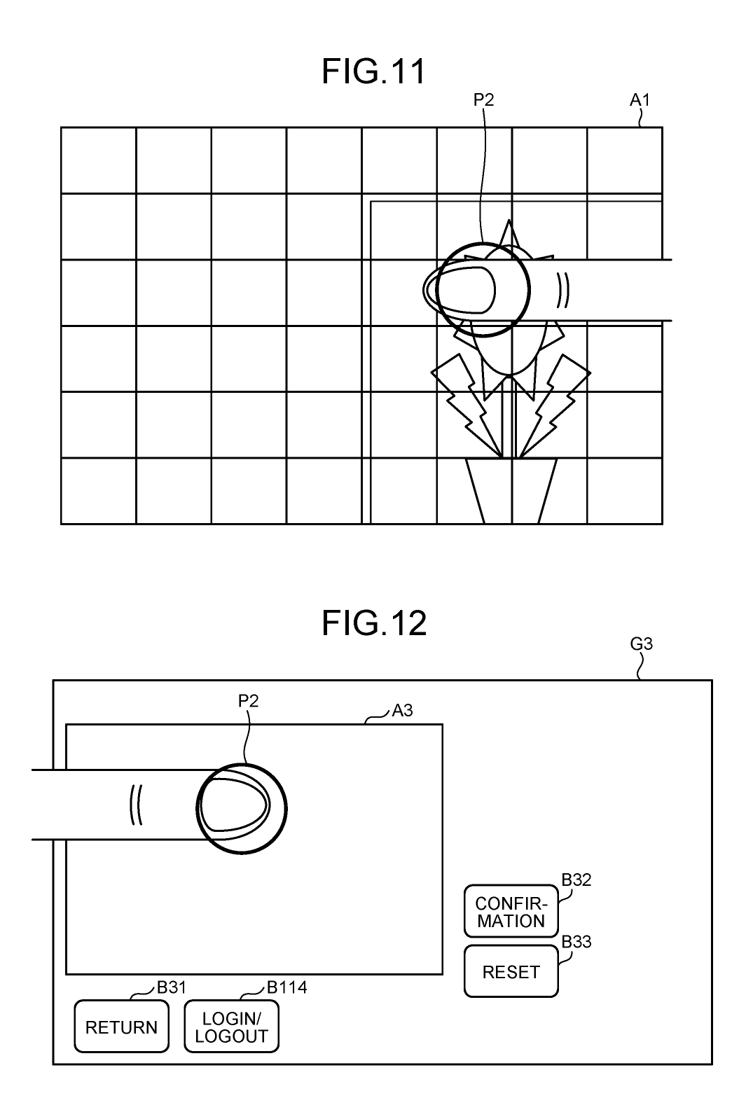

The guide image is not limited to the example in FIG. 10, and another mode may be adopted. In the image forming apparatus 2 according to the present embodiment, the object of the camera unit 20 is not limited to a document. Thus, the focus position may not match with the document size. Hence, for example, as illustrated in FIG. 11, a guide image having only a grid pattern may be displayed on the area A1.

FIG. 11 is a diagram illustrating another example of the guide image. In FIG. 11, a guide image of a grid pattern is transparently displayed on the picked up image (image of a flower) displayed on the area A1. In this example, the user of the image forming apparatus 2 can indicate the focus position of the camera unit 20, by specifying a desired position on the area A1 through a touch operation. For example, upon receiving an operation to specify a position P2, the system controller 51 sets the focus position of the camera unit 20 at the position corresponding to the position P2. It is preferable that the guide images in FIG. 10 and FIG. 11 are configured to be switchable. For example, they may be switched by a toggle operation using the focus button B22. An operating element dedicated for switching the screen may be provided. It is also possible to perform an operation for specifying the focus position directly on the picked up image in the area A1, without displaying the guide image.

In the examples in FIG. 10 and FIG. 11, the camera image screen G2 is used for specifying the focus position. However, it is not limited thereto, and the focus position may be specified from another screen. More specifically, upon receiving an operation of the focus button B22, the system controller 51 displays a screen for specifying a focus position (focus position specification screen) on the display device 31, by collaborating with the UI controlling unit 103.

FIG. 12 is a diagram illustrating an example of a focus position specification screen. As illustrated in FIG. 12, a focus position specification screen G3 has a return button B31, a confirmation button B32, and a reset button B33, in addition to the login/logout button B114 described above. The return button B31 is an operating element for returning to the preceding screen. The confirmation button B32 is an operating element for confirming the focus position. The reset button B33 is an operating element for resetting the focus position set temporarily. The focus position specification screen G3 also has an area A3. The system controller 51 displays an image picked up by the camera unit 20 on the area A3. The system controller 51 also displays the focus position currently being set in a superimposed manner, on the picked up image in the area A3.

In the focus position specification screen G3, for example, the system controller 51 displays the guide image described above on the area A3, by collaborating with the UI controlling unit 103. The user of the image forming apparatus 2 can indicate the focus position of the camera unit 20, by specifying a desired position on the area A3 through a touch operation, in the same way as described above. For example, upon receiving an operation to specify the position P2, the system controller 51 temporarily sets the focus position of the camera unit 20 at the position corresponding to the position P2. When the confirmation button B32 is operated at this state, the system controller 51 confirms the focus position set temporarily as the formal setting, and returns to the preceding screen by erasing the focus position specification screen G3. When the reset button B33 is operated, the system controller 51 resets the focus position set temporarily, and returns the setting to a default focus position determined in advance.

The focus button B22 may be provided on the other screen instead of the camera image screen G2. For example, the focus button B22 may be provided on the UIs of various functions (copy function, conference function, presentation function, and the like) that use the picked up image of the camera unit 20.

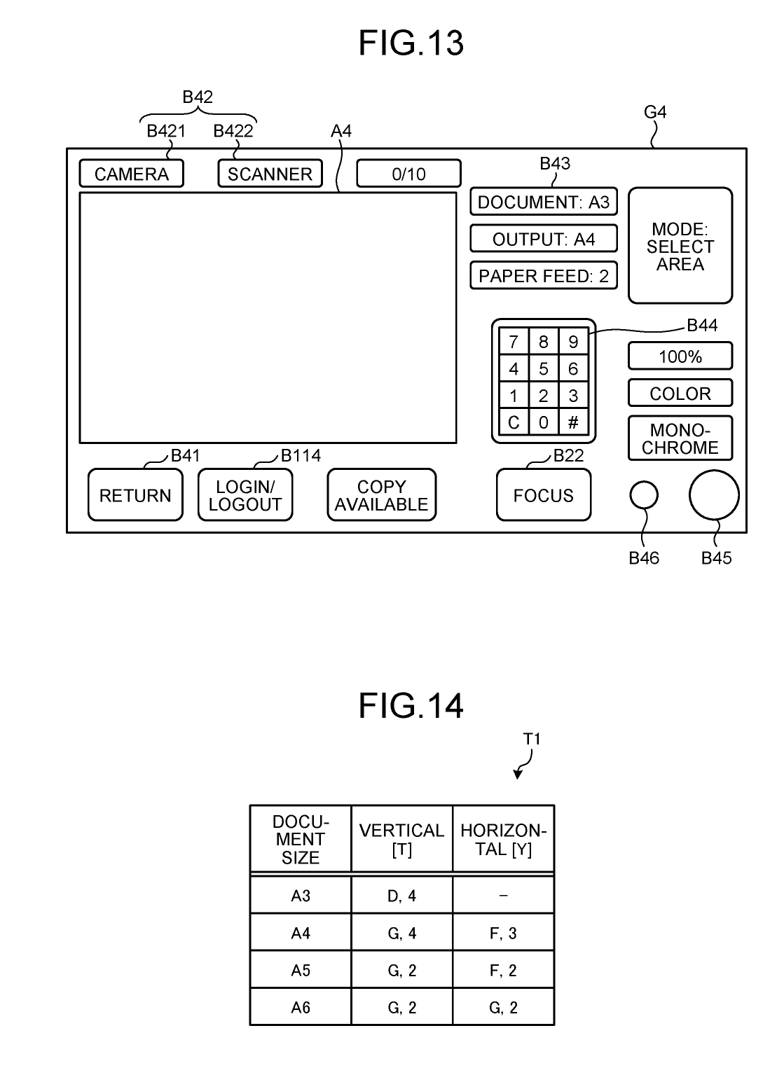

Here, FIG. 13 is a diagram illustrating an example of a copy screen according to a copy function. A copy screen G4 is a UI displayed when the copy button B116 on the initial screen G1 in FIG. 7 or on the camera image screen G2 in FIG. 8 is operated.

As illustrated in FIG. 13, the copy screen G4 has a return button B41, an input source selection button B42, a document size specification button B43, numerical keys B44, a start button B45, and a clear button B46, in addition to the login/logout button B114 and the focus button B22 described above. The return button B41 is an operating element for returning to the preceding screen (initial screen G1 or camera image screen G2). The input source selection button B42 includes a camera button B421 that specifies the camera unit 20 and a scanner button B422 that specifies the scanner unit 40. When either of the camera button B421 or the scanner button B422 is selected, the copy function unit 87 copies and prints image data, by using the image data input from the selected device. The document size specification button B43 is an operating element for specifying the size of a document to be copied. The numerical keys B44 are operating elements for specifying the number of sheets to be copied and the like. The start button B45 is an operating element to start copying. The clear button B46 is an operating element for clearing the setting content set via the document size specification button B43 and the like.

The copy screen G4 has an area A4. When the camera button B421 is selected, an image picked up by the camera unit 20 is displayed on the area A4. When the scanner button B422 is operated, an image scanned by the scanner unit 40 is displayed on the area A4.

In the copy screen G4, when the camera button B421 is selected and the focus button B22 is operated, the system controller 51 transparently displays the guide image on the picked up image in the area A4 in the same way as described above. The system controller 51 then changes the focus position of the camera unit 20, through a touch operation on the area A4.

When the copy screen G4 is used, the focus position of the camera unit 20 may be changed according to the document size specified via the document size specification button B43. For example, when this configuration is adopted, the storage unit 57 of the image forming apparatus 2 stores in advance a focus position setting table and the like that defines the focus position of each document size, and the focus position of the camera unit 20 is determined based on the focus position setting table.

Here, FIG. 14 is a schematic diagram illustrating an example of a data configuration of a focus position setting table. As illustrated in FIG. 14, a focus position setting table T1 stores therein coordinates of a focus position for each document size, corresponding to the document size. For example, the coordinates (G, 2) are associated with the document size of A6T. The coordinates (D, 4) are associated with the document size of A3. Each of the coordinates in the focus position setting table T1 corresponds to the position coordinates on the guide image illustrated in FIG. 10.

When the camera button B421 is selected and the document size is specified by the document size specification button B43, the system controller 51 reads out the coordinates of the focus position corresponding to the document size, from the focus position setting table T1. The system controller 51 then sets the focus position of the camera unit 20, to the coordinates being read out.

An operation of the image forming apparatus 2 according to the changing in the setting of the focus position described above will now be explained.

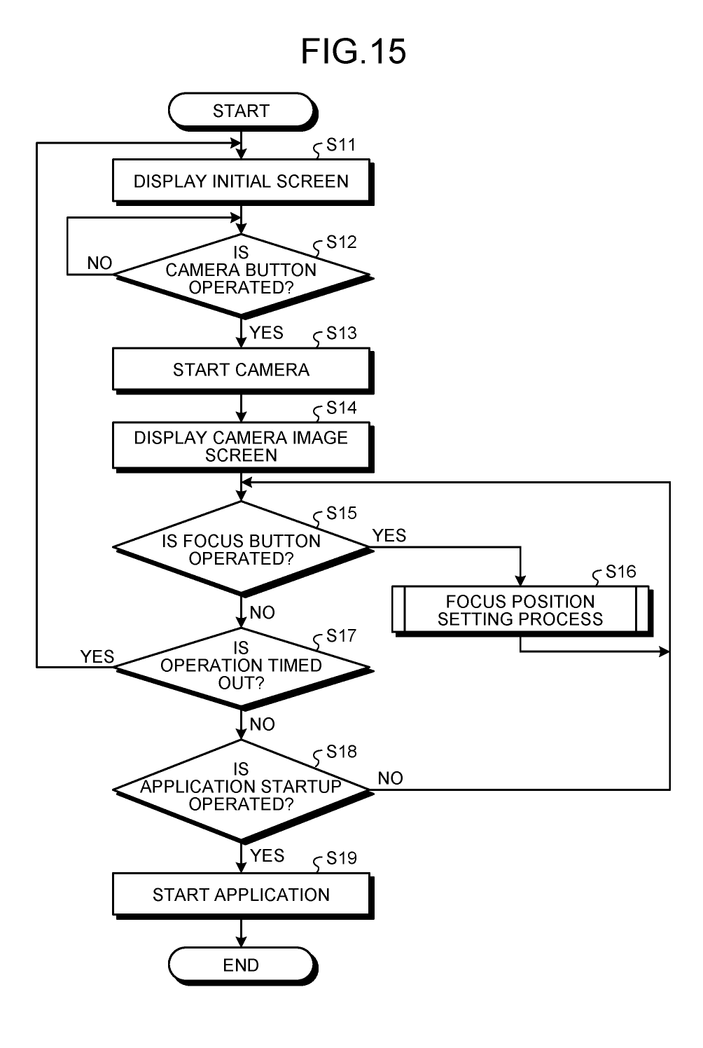

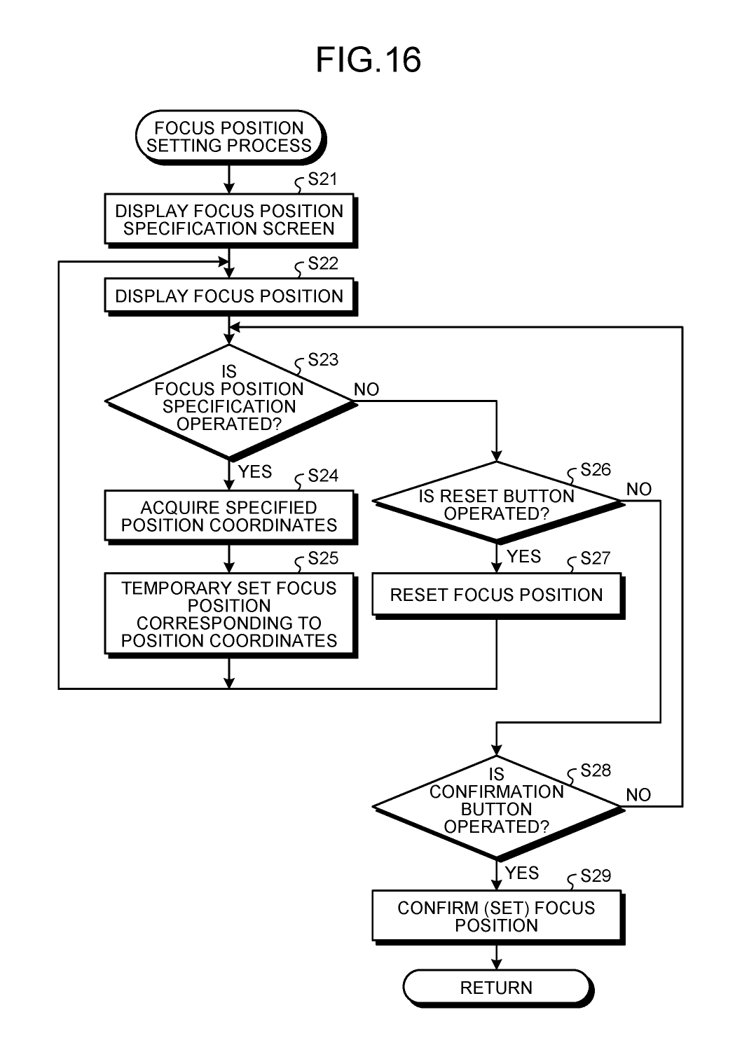

A procedure of an operation receiving process performed while the camera image screen G2 is displayed, will now be described with reference to FIG. 15 and FIG. 16. Here, FIG. 15 is a flowchart illustrating an example of a procedure of an operation receiving process. In the present process, the focus position specification screen G3 is displayed when the focus button B22 is operated.

The system controller 51 displays the initial screen G1 on the display device 31 (step S11). Then, the system controller 51 stands by until the camera button B111 is operated (No at step S12). Upon receiving an operation of the camera button B111 (Yes at step S12), the system controller 51 starts the camera unit 20 (step S13), and displays the camera image screen G2 on the display device 31 (step S14).

The system controller 51 then determines whether the focus button B22 is operated (step S15). Upon receiving an operation of the focus button B22 (Yes at step S15), the system controller 51 executes a focus position setting process (step S16).

FIG. 16 is a flowchart illustrating an example of a procedure of a focus position setting process. The system controller 51 displays the focus position specification screen G3 on the display device 31 (step S21). The system controller 51 then displays the focus position currently being set on the picked up image in the area A4 in a superimposed manner (step S22). At the initial state, a default focus position set in advance is displayed on the area A4.

Then, the system controller 51 stands by for an operation from the user (No at step S23; No at step S26; and No at step S28). Upon receiving an operation to specify the focus position on the area A4 (Yes at step S23), the system controller 51 acquires the specified position coordinates (step S24). The system controller 51 then temporarily sets the focus position of the camera unit 20 based on the acquired position coordinates (step S25), and returns to step S22.

If the reset button B33 is operated (Yes at step S26), the system controller 51 resets the focus position currently being set (step S27). The system controller 51 then displays the default focus position on the area A4, by returning to step S22.

If the confirmation button B32 is operated (Yes at step S28), the system controller 51 confirms (sets) the focus position currently being set (step S29), and returns to the original process. The focus position set by this focus position setting process will be passed on to the subsequent processes.

Returning to FIG. 15, when the focus position setting process is finished, the system controller 51 returns to step S15. At step S15, if the focus button B22 is not operated (No at step S15), the system controller 51 determines whether the elapsed time from when the preceding operation is performed has reached a predetermined timeout time (step S17). If it is determined that it has not reached the timeout time (No at step S17), the system controller 51 determines whether an application startup operation for activating the application is performed (step S18).

At step S18, upon receiving the application startup operation (Yes at step S18), the system controller 51 activates the indicated application (function unit) by starting it (step S19), and terminates the present process. After the application is started, the system controller 51 displays the UI according to the application on the display device 31.

At step S17, upon determining that it has reached the timeout time (Yes at step S17), the system controller 51 displays the initial screen G1 again, by returning to step S11. At step S18, if the application startup operation has not been received (No at step S18), the system controller 51 stands by for an operation from the user until it has reached the timeout time, by returning to step S15.

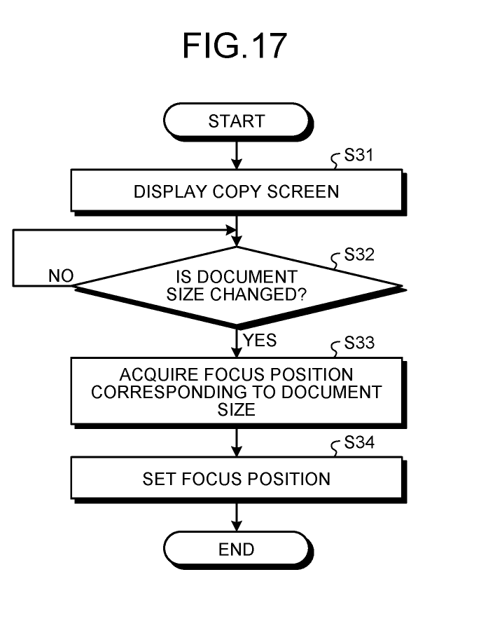

A process for setting the focus position performed via the copy screen G4 will now be described with reference to FIG. 17. Here, FIG. 17 is a flowchart illustrating an example of a procedure of a document size changing process. As a premise of the present process, it is assumed that the copy screen G4 is displayed on the display device 31 (step S31).

The system controller 51 stands by until an operation for changing the document size is performed on the copy screen G4 (No at step S32). Here, upon receiving the changing operation of the document size via the document size specification button B43 (Yes at step S32), the system controller 51 acquires the focus position corresponding to the document size, from the focus position setting table T1 (step S33). The system controller 51 then sets the focus position acquired at step S33 to the camera unit 20 (step S34), and terminates the present process.

As described above, according to the first characteristic of the image forming apparatus 2, the focus position of the camera unit 20 can be set to any position. Thus, it is possible to pick up images of various objects such as a document in a suitable state. According to the first characteristic of the image forming apparatus 2, the focus position is changed according to the changing operation of the document size. Thus, it is possible to pick up an image of a document of each size in a suitable state.

Next, an operation according to the exchange of image data with the other image forming apparatus 2 will be described as the second characteristic of the image forming apparatus 2.

In the image forming apparatus 2, when the conference button B124 or the like illustrated in the initial screen G1 (refer to FIG. 7) is operated, it is possible to exchange image data and sound data with the other image forming apparatus 2.

More specifically, upon receiving an operation of the conference button B124, the system controller 51 operates the camera unit 20, and distributes (transmits) the moving image data picked up by the camera unit 20 together with the sound data, to the other image forming apparatus 2. The system controller 51 also receives the moving image data and the sound data transmitted from the other image forming apparatus 2.

Here, the system controller 51 controls to temporality store (retain) the moving image data (first moving image data) picked up by the camera unit 20 in the storage medium such as the RAM. From the temporarily stored moving image data, the system controller 51 controls to generate moving image data (second moving image data) for streaming distribution the data quantity of which such as resolution is reduced. The system controller 51 then controls the moving image data to be distributed to the other image forming apparatus 2. Consequently, the image quality of the moving image data to be distributed from the own device to the other image forming apparatus 2, is lower than the original image quality of the moving image data picked up by the camera unit 20 of the own device.

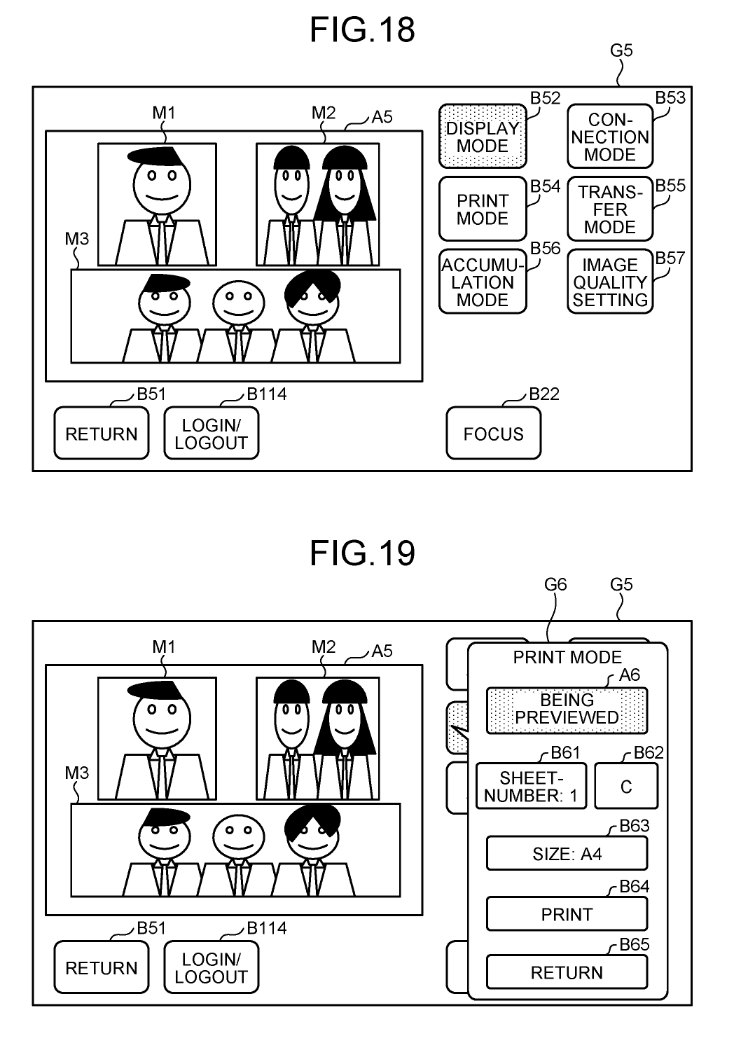

The system controller 51 also displays a UI for the video conference (conference screen G5) on the display device 31, by collaborating with the UI controlling unit 103. Here, FIG. 18 is a diagram illustrating an example of the conference screen G5. The conference screen G5 has an area A5. The system controller 51 displays the moving image data picked up by the camera unit 20 of the own device and the moving image data transmitted from the other image forming apparatus 2 communicating with the own device, on the area A5, as the picked up images of the image forming apparatuses 2. In FIG. 18, it is assumed that a video conference is performed among three image forming apparatuses 2 including the own device. Thus, three picked up images M1 to M3 picked up by the three image forming apparatuses 2 including the own device are displayed on the area A5. It is also possible not to display the picked up image of the own device, on the area A5.

The picked up images displayed on the area A5 are configured to be selectable. The user can select one or all of the picked up images, for example, through a touch operation on the picked up images. Upon receiving the selection of the picked up image through the operations of various mode buttons, which will be described below, the system controller 51 sets the selected picked up image or the image forming apparatus 2 that picks up the picked up image, as an object to be processed corresponding to the mode button.

The conference screen G5 has a return button B51, in addition to the login/logout button B114 and the focus button B22 described above. Here, the return button B51 is an operating element for returning to the preceding screen.

The conference screen G5 also has various mode buttons B52 to B57. The display mode button B52 is an operating element for changing the display mode of the picked up image to be displayed on the area A5. For example, the UI controlling unit 103 changes the display position and the display sequence of the picked up images, every time the display mode button B52 is pressed.

A connection mode button B53 is an operating element for specifying the other image forming apparatus 2, which is to be a communication destination. Upon receiving an operation of the connection mode button B53, the system controller 51 displays a screen (not illustrated) for specifying the communication destination, and establishes communication with the specified other image forming apparatus 2. For example, such a screen has a screen configuration that can select the image forming apparatus 2 as a communication partner, from the image forming apparatuses 2 connected to the network N.

A print mode button B54 is an operating element for printing the picked up image displayed on the area A5. Upon receiving an operation of the print mode button B54, the system controller 51 displays a print mode screen as illustrated in FIG. 19. Here, FIG. 19 is a diagram illustrating an example of a print mode screen. Upon receiving an operation of the print mode button B54, the system controller 51 displays a print mode screen G6 on the conference screen G5. At this state, for example, the user can specify the picked up image to be printed, by selecting a picked up image displayed on the area A5.

The print mode screen G6 has an area A6 for indicating the printing state. In FIG. 19, “being previewed” is displayed on the area A6 as the printing state. The print mode screen G6 also includes a sheet-number setting button B61, a clear button B62, a size setting button B63, a print button B64, and a return button B65.

The sheet-number setting button B61 is an operating element for setting the number of sheets to be printed. For example, the sheet-number setting button B61 is configured so that the number of sheets to be printed is increased one by one, every time it is operated (pressed). The clear button B62 is an operating element for clearing the number of sheets to be printed or to interrupt printing. The size setting button B63 is an operating element for setting the sheet size. For example, the size setting button B63 is configured so that the setting of the sheet size is switched by a toggle operation. The print button B64 is an operating element for executing printing. The return button B65 is an operating element for erasing the print mode screen G6.

Returning to FIG. 18, a transfer mode button B55 is an operating element for transferring various types of data (conference materials and the like) stored in the storage unit 57 and the like to the other image forming apparatus 2. Upon receiving an operation of the transfer mode button B55, the system controller 51 displays a screen (not illustrated) for specifying the data to be transferred. The system controller 51 then transfers the data to be transferred to the other image forming apparatus 2 selected via the picked up image on the area A5.

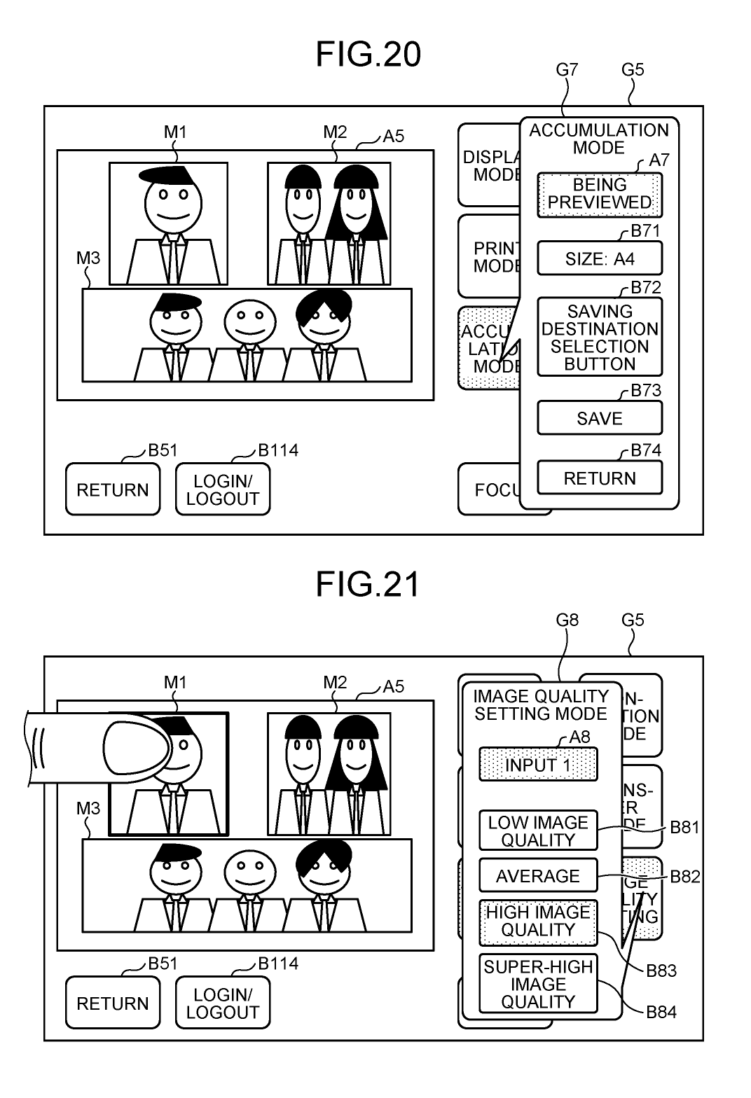

An accumulation mode button B56 is an operating element for accumulating the picked up images displayed on the area A5. Upon receiving an operation of the accumulation mode button B56, the system controller 51 displays an accumulation mode screen as illustrated in FIG. 20. Here, FIG. 20 is a diagram illustrating an example of an accumulation mode screen. Upon receiving an operation of the accumulation mode button B56, the system controller 51 displays an accumulation mode screen G7 on the conference screen G5. At this state, for example, the user can specify the picked up image to be accumulated, by selecting the picked up image displayed on the area A5.

The accumulation mode screen G7 has an area A7 for indicating the accumulation state. In FIG. 20, “being previewed” is displayed on the area A7, as the accumulation state. The accumulation mode screen G7 also has a size setting button B71, a saving destination selection button B72, a save button B73, and a return button B74.

The size setting button B71 is an operating element for setting the image size. The size setting button B71 corresponds to a second specification unit in the present embodiment. For example, the size setting button B71 is configured so that the setting of the image size is switched by a toggle operation. The saving destination selection button B72 is an operating element for indicating the accumulation (saving) destination of image data (still image data). For example, the saving destination selection button B72 is configured so that the saving destination device such as the storage unit 57 and a device connected to the input/output I/F 52 is switched by a toggle operation. The save button B73 is an operating element for accumulating (saving) image data (still image data). The return button B74 is an operating element for erasing the accumulation mode screen G7.

Returning to FIG. 18, the conference screen G5 has an image quality setting button B57. The image quality setting button B57 is an operating element for setting the image quality of image data (still image data). Upon receiving an operation of the image quality setting button B57, the system controller 51 displays an image quality setting mode screen as illustrated in FIG. 21. Here, FIG. 21 is a diagram illustrating an example of an image quality setting mode screen. Upon receiving an operation of the image quality setting button B57, the system controller 51 displays an image quality setting mode screen G8 on the conference screen G5.

The image quality setting mode screen G8 has an area A8 for indicating the picked up image to be set. As illustrated in FIG. 21, the user can specify the picked up image to be set, by selecting one of the picked up images displayed on the area A5. In FIG. 21, a picked up image M1 at the upper left is an “input 1”, a picked up image M2 at the upper right is an “input 2”, and a picked up image M3 at the lower center is an “input 3”, and in the example, the “input 1” is selected.

The image quality setting mode screen G8 has four image quality specification buttons B81 to B84 to specify the image quality. The image quality specification buttons B81 to B84 correspond to a first specification unit in the present embodiment. In FIG. 21, four levels of image qualities of “low image quality”, “average”, “high image quality”, and “super-high image quality” can be specified.

In the print mode and the accumulation mode described above, upon receiving the selection operation of a picked up image to be printed or to be accumulated from the area A5 (hereinafter, referred to as a trigger operation), the system controller 51 transmits an acquisition request for still image data to the image forming apparatus 2, which is a transmission source of the picked up image. In other words, the trigger operation corresponds to an operation for acquiring still image data. Here, the system controller 51 may also include image quality information indicating the image quality set on the image quality setting mode screen G8, in the acquisition request. When the image size is set by the size setting button B71 on the accumulation mode screen G7, the system controller 51 may include the image size information indicating the image size, in the acquisition request.

The system controller 51 at the side of the image forming apparatus 2 that receives the acquisition request generates still image data from the moving image data picked up by the camera unit 20, and transmits it to the image forming apparatus 2 of the request source. Here, when the image quality information and the image size information are included in the acquisition request, the system controller 51 generates still image data of the image quality and image size indicated by the information, and transmits it to the image forming apparatus 2 of the request source.

For example, when the indicated image quality is the “super-high image quality”, the system controller 51 sets the still image data by extracting still image data of one frame from the moving image data picked up by the camera unit 20. In this case, the image quality of the still image data is higher compared to the image quality of the moving image data to be distributed. When the indicated image quality is the “high quality”, “average”, or “low quality”, the system controller 51 sets the still image data by converting still image data of one frame extracted from the moving image data picked up by the camera unit 20, to the resolution according to each image quality. If the image size is indicated, the system controller 51 converts the image size of the still image data extracted from the moving image data, to the indicated image size. If the image quality and image size are not indicated, the still image data extracted from the moving image data may be used as it is, or may convert it to a default resolution or image size determined in advance. If it is converted into a default resolution, it is preferable that the default resolution is higher than the resolution for streaming distribution.

At the side of the image forming apparatus 2 of the request source, upon receiving still image data, the system controller 51 temporarily stores the still image data in the RAM and the like, and displays it on the display device 31 as a preview. For example, the system controller 51 displays the acquired still image data on the area A5, instead of the corresponding picked up image. The system controller 51 then executes a process according to the operated mode button, on the acquired still image data. For example, when the print button B64 described above is operated, the system controller 51 causes the printing unit 12 to print the acquired still image data. When the save button B73 described above is operated, the system controller 51 saves the acquired still image data in the saving destination selected via the saving destination selection button B72.

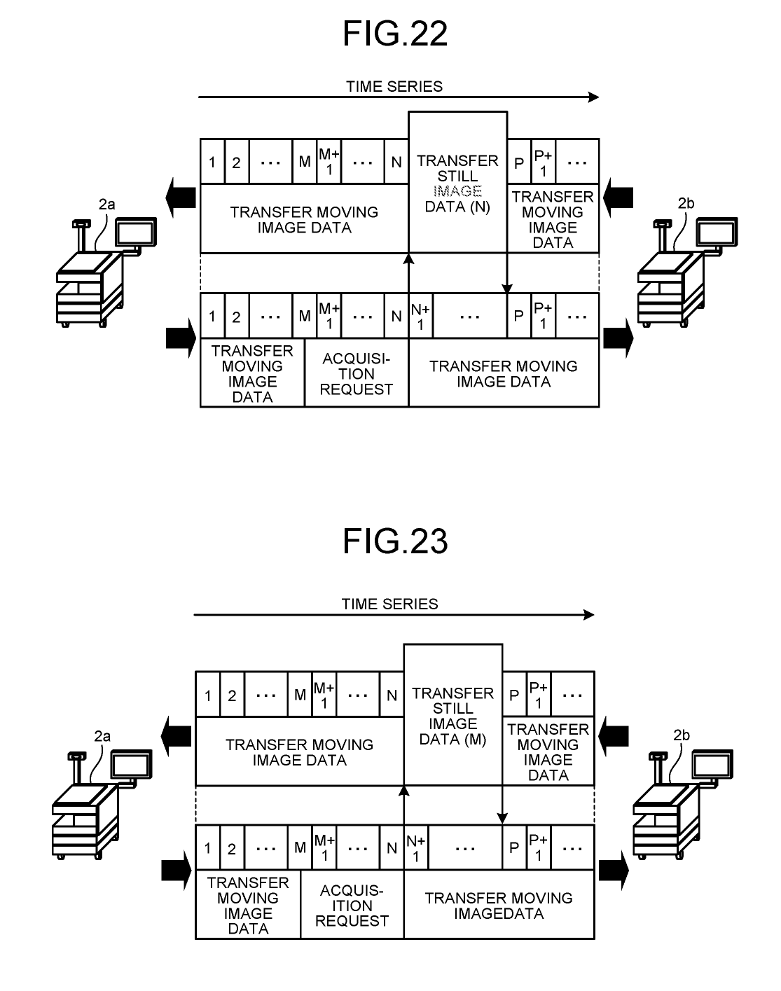

FIG. 22 is a schematic diagram illustrating an example of data transfer according to the exchange of still image data. In FIG. 22, a chart illustrated between an image forming apparatus 2a and an image forming apparatus 2b is a flow of data between the two devices. The horizontal axis is a time axis indicating the time series, displaying the elapsed time from the left side to the right side. The vertical axis displays the data quantity to be transferred. Also, 1, 2, . . . M, M+1, . . . , N, N+1, . . . , P, P+1, . . . are time information indicating the timing (such as time code and frame number) of the picked up image (moving image data). It is assumed that the image forming apparatus 2a and the image forming apparatus 2b are transmitting and receiving moving image data for a video conference. It is also assumed that a measure for eliminating the time lag according to the transmission and reception of moving image data has been taken between the transmission side and the reception side.

When a trigger operation is performed at the specific timing M in the image forming apparatus 2a, the system controller 51 of the image forming apparatus 2a generates an acquisition request according to the trigger operation, and transmits it to the image forming apparatus 2b.

In the image forming apparatus 2b, upon receiving the acquisition request at the timing N, the system controller 51 of the image forming apparatus 2b generates still image data of the frame distributed at the timing N. The system controller 51 of the image forming apparatus 2b then transmits (transfers) the generated still image data to the image forming apparatus 2a.

In this manner, the image forming apparatus 2 of the distribution side that distributes moving image data can provide still image data of image quality (resolution and image size) different from that of the moving image data being distributed, to the image forming apparatus 2 of the reception side that receives the moving image data. In FIG. 22, the data is transferred between the two devices of the image forming apparatus 2a and the image forming apparatus 2b. However, the same applies when the data is transferred among three or more devices.

In the configuration in FIG. 22, a time lag occurs between the operation timing (timing M) when the trigger operation is performed in the image forming apparatus 2a and the generation timing (timing N) when the still image data is generated in the image forming apparatus 2b. Thus, it is possible to eliminate the time lag by including the time information indicating the timing when the trigger operation is performed in the acquisition request. Hereinafter, the configuration will be described with reference to FIG. 23.

FIG. 23 is a schematic diagram illustrating another example of the data transfer according to the exchange of still image data. The meanings of the horizontal axis, the vertical axis, and the like in FIG. 23 are the same as those in FIG. 22.

When a trigger operation is performed at the specific timing M in the image forming apparatus 2a, the system controller 51 of the image forming apparatus 2a generates an acquisition request including the time information indicating the timing M, and transmits it to the image forming apparatus 2b.

In the image forming apparatus 2b, upon receiving the acquisition request at the timing N, the system controller 51 of the image forming apparatus 2b generates still image data of the frame distributed at the timing M, based on the time information included in the acquisition request. The system controller 51 of the image forming apparatus 2b then transmits (transfers) the generated still image data to the image forming apparatus 2a. If the present configuration is adopted, the image forming apparatus 2 that distributes the moving image data retains the moving image data of a predetermined period of time (such as ten seconds) picked up by the camera unit 20, in the RAM and the like. A method for retaining the moving image data is optional, but for example, a ring buffer may be used so that the moving image data are sequentially retained in an overwriting manner.

In this manner, in the image forming apparatus 2, the time information indicating the timing when the trigger operation is performed, is included in the acquisition request to be transmitted. Thus, it is possible to acquire the still image data of the moving image data displayed (distributed) at the timing.

If the moving image data (still image data) is not present at the timing indicated by the acquisition request (time information), the system controller 51 distributes error information indicating that effect, to the image forming apparatus 2 that transmitted the acquisition request. In this case, the still image data closest to the indicated timing or the still image data when the acquisition request is received, may be distributed together with the error information.

Similarly, if the still image data of the image quality indicated by the acquisition request (image quality information and image size) cannot be generated, the system controller 51 transmits error information indicating that effect, to the image forming apparatus 2 that transmitted the acquisition request. In this case, the still image data extracted from the moving image data or the still image data closest to the indicated image quality, may be generated and transmitted together with the error information.

In the image forming apparatus 2 that received error information, the error is displayed in association with the relevant picked up image on the conference screen G5, by collaborating with the UI controlling unit 103.

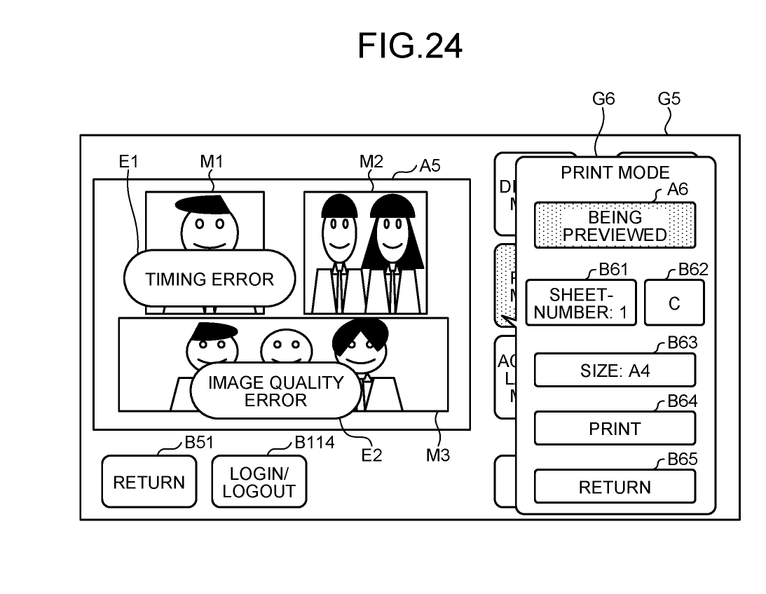

Here, FIG. 24 is a diagram illustrating an example of the conference screen G5 when errors are displayed. In FIG. 24, it is assumed that an acquisition request for still image data is transmitted to the picked up images M1 and M3 on the area A5. Here, error information E1, which indicates that still image data is not present at the timing indicated by the acquisition request (time information), is displayed on the picked up image M1. In addition, error information E2 indicating that still image data of the image quality indicated by the acquisition request (image quality information) is not present, is displayed on the picked up image M3.

In the explanation described above, the trigger operation to start acquiring still image data is operated by selecting the picked up image displayed on the area A5. However, it is not limited thereto. For example, an operation on the print mode button B54 or the accumulation mode button B56 may be a trigger operation. An operation on the print button B64 or the save button B73 may also be a trigger operation.

An operation of the image forming apparatus 2 according to the exchange of still image data described above will now be explained.

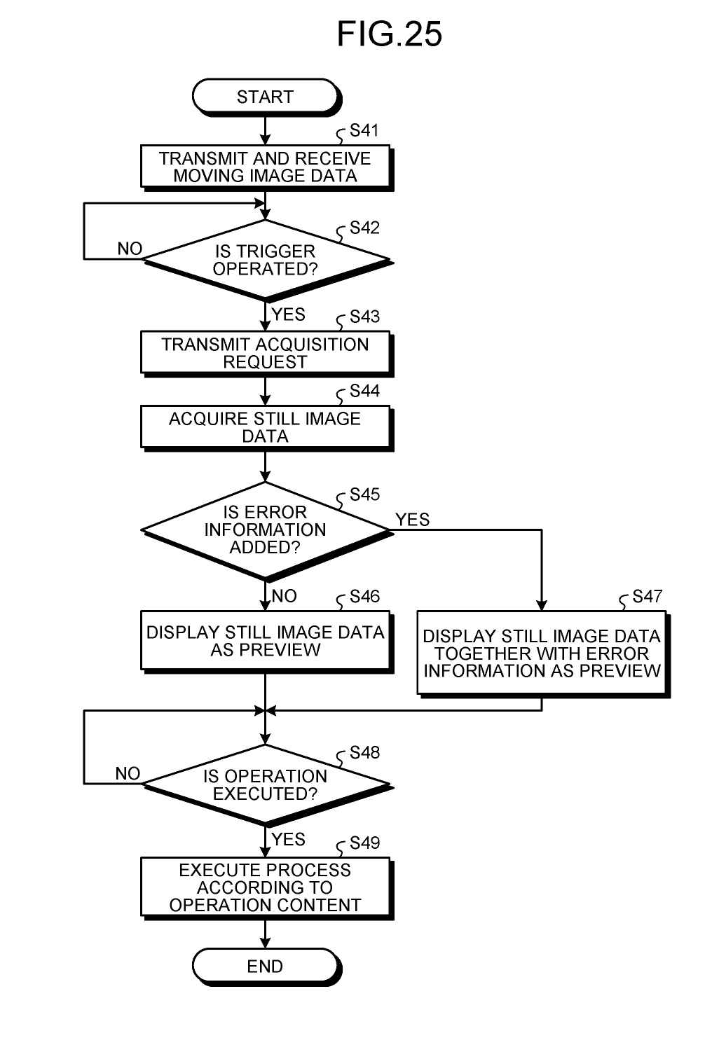

An operation of the image forming apparatus 2 at the side that receives still image data will now be described with reference to FIG. 25. Here, FIG. 25 is a flowchart illustrating an example of a procedure of a still image data acquiring process. In the present process, still image data is acquired at the timing when the trigger operation is performed. In the present process, if still image data cannot be generated under the condition indicated by the acquisition request, substitute still image data is received together with error information.

As a premise of the present process, it is assumed that the conference screen G5 is displayed on the display device 31, and moving image data is exchanged (transmitted and received) with the other image forming apparatus 2 (step S41).

The system controller 51 stands by until a trigger operation for acquiring still image data is performed (No at step S42). Upon receiving the trigger operation (Yes at step S42), the system controller 51 generates an acquisition request including the time information that indicates the timing when the trigger operation is performed, the image quality information, and the like, and transmits it to the other image forming apparatus 2 (step S43).

The system controller 51 acquires still image data from the other image forming apparatus 2 (step S44), as a response to the acquisition request. The system controller 51 then determines whether error information is added to the acquired still image data (step S45). Here, if the error information is not added (No at step S45), the system controller 51 displays the acquired still image data on the display screen as a preview (step S46), and proceeds to step S48.

If the error information is added to the still image data (Yes at step S45), the system controller 51 displays the acquired still image data together with the error information on the display device as a preview (step S47), and proceeds to step S48.

The system controller 51 then stands by until the operating element for executing printing or accumulation is operated (No at step S48). If the execution of printing or accumulation is instructed (Yes at step S48), the system controller 51 executes the process of printing or accumulation by using the acquired still image data (step S49), and terminates the present process.

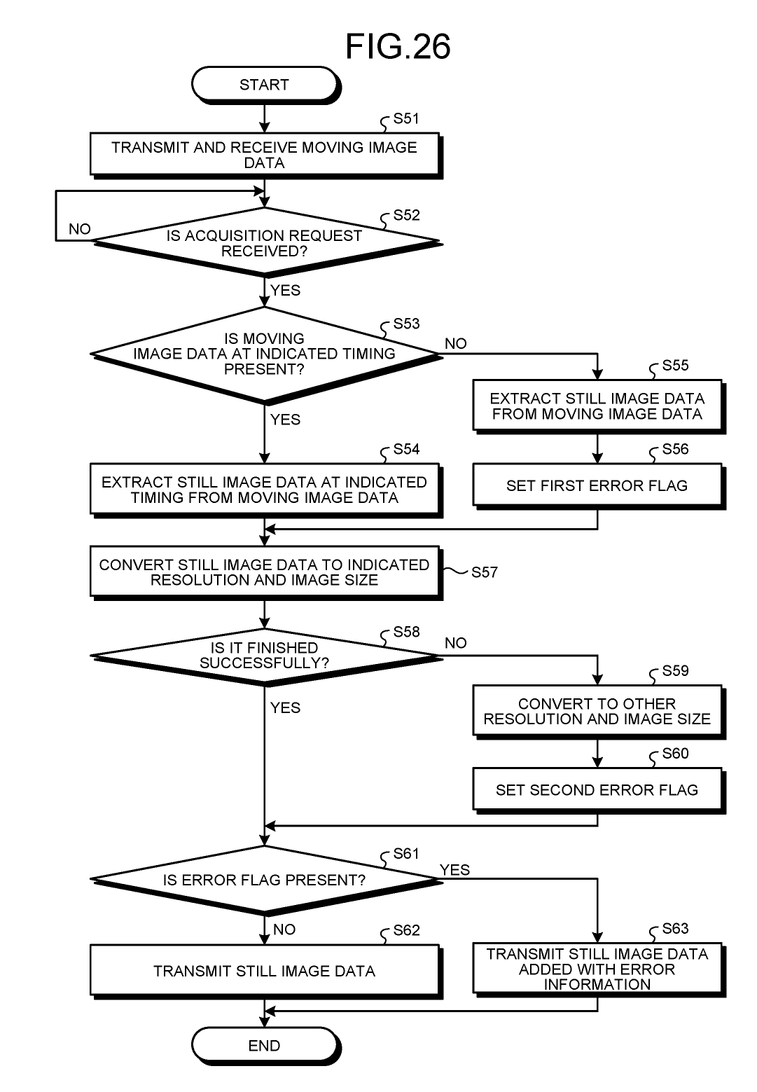

An operation of the image forming apparatus 2 at the side that transmits still image data will now be described with reference to FIG. 26. Here, FIG. 26 is a flowchart illustrating an example of a procedure of a still image data providing process. In the present process, still image data at the timing when the trigger operation is performed, is acquired. In the present process, if the still image data cannot be generated under the condition indicated by the acquisition request, substitute still image data is transmitted with the error information.

As a premise of the present process, it is assumed that the conference screen G5 is displayed on the display device 31 and moving image data is exchanged (transmitted and received) with the other image forming apparatus 2 (step S51).

The system controller 51 stands by until an acquisition request is received from the other image forming apparatus 2 (No at step S52). Upon receiving the acquisition request (Yes at step S52), the system controller 51 determines whether the moving image data at the timing indicated by the acquisition request (time information) is retained (step S53). If it is determined that the moving image data is retained (Yes at step S53), the system controller 51 extracts the still image data at the indicated timing from the retained moving image data (step S54), and proceeds to step S57.

If it is determined that the moving image data is not retained (No at step S53), the system controller 51 extracts still image data from the retained moving image data (step S55). The system controller 51 then sets a first error flag (step S56), and proceeds to step S57.

At the subsequent step S57, the system controller 51 executes a process of converting the still image data extracted at step S54 or step S55 to the resolution and the image size according to the image quality and the image size indicated by the acquisition request (image quality information and image size) (step S57). The system controller 51 then determines whether the process at step S57 has finished successfully (step S58). If it is determined that it has finished successfully (Yes at step S58), the system controller 51 proceeds to step S61.

If it is determined that the conversion process has failed (No at step S58), the system controller 51 converts the still image data to the other resolution or the image size (step S59). The system controller 51 then sets a second error flag (step S60), and proceeds to step S61. The resolution or the image size to be converted at step S59 is optional, as long as the conversion process finishes successfully.

The system controller 51 then determines whether an error flag (first error flag or second error flag) is set on the generated still image data (step S61). If it is determined that the error flag is not set (No at step S61), the system controller 51 transmits the generated still image data to the other image forming apparatus 2 of the request source (step S62), and terminates the present process.

If it is determined that the error flag is set (Yes at step S61), the system controller 51 adds error information according to the error flag to the generated still image data. The system controller 51 then transmits the still image data added with the error information to the other image forming apparatus 2 of the request source (step S63), and terminates the present process.

As described above, according to the second characteristic of the image forming apparatus 2, the image forming apparatus 2 of the reception side, which receives the distribution of moving image data, transmits an acquisition request for still image data to the image forming apparatus 2 of the distribution side, according to the instruction from the user. The image forming apparatus 2 of the distribution side generates still image data from the moving image data, which is picked up by the camera unit 20, according to the acquisition request. The image forming apparatus 2 of the distribution side then provides the still image data to the image forming apparatus 2 of the reception side. Thus, the image forming apparatus 2 of the reception side can acquire the still image data having higher image quality from the moving image data being distributed from the image forming apparatus 2 of the distribution side. Consequently, it is possible to use the still image data having higher image quality for printing, saving, and the like in a suitable manner.

The image forming apparatus 2 of the reception side transmits the time information that indicates the timing of the moving image data displayed at the time of trigger operation, by including it in the acquisition request. Thus, it is possible to acquire the still image data at the timing. The image forming apparatus 2 of the reception side transmits the image quality information that indicates the image quality specified via the image quality specification buttons B81 to B84, by including it in the acquisition request. Thus, it is possible to acquire the still image data having the indicated image quality. Furthermore, the image forming apparatus 2 of the reception side transmits the image size information indicating the image size specified via the size setting button B71 by including it in the acquisition request. Thus, it is possible to acquire the still image data having the indicated image size. Consequently, it is possible to improve the convenience of the user who acquires the still image data.

If the still image data cannot be generated under the condition indicated by the acquisition request, the image forming apparatus 2 of the distribution side provides substitute still image data to the image forming apparatus 2 of the reception side, together with the error information. Thus, the image forming apparatus 2 of the reception side can print and save by using the substitute still image data. Hence, it is possible to improve the convenience of the user.

### Second Embodiment

In the first embodiment, the configuration of the image forming apparatus 2 that can change the image pickup direction and the focus position of the camera unit 20 has been described. The image forming apparatus 2 described above is provided with a plurality of functions (applications) that use the camera unit 20 such as the copy function and presentation function. In such a case, the same setting value of the image pickup direction and the focus position of the camera unit 20 may be used for each application every time. However, it is troublesome for the user to reset the image pickup direction and the focus position of the camera unit 20, every time the application is started.

The second embodiment describes a configuration in which the setting value of the image pickup direction and the focus position of the camera unit 20 can be saved for each application. The same constituent elements as those in the first embodiment are denoted by the same reference numerals and a detailed description thereof will be omitted.

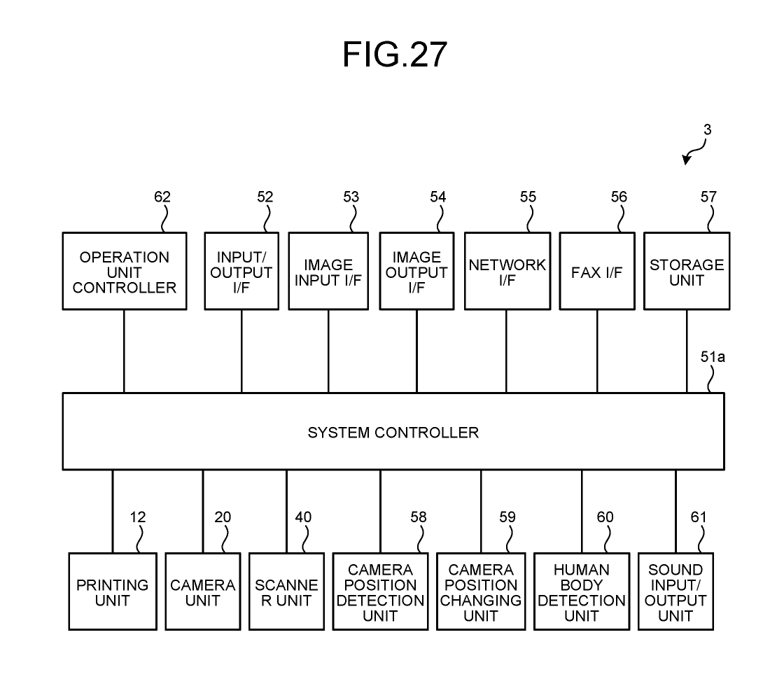

FIG. 27 is a block diagram illustrating an example of a hardware configuration of an image forming apparatus 3 according to the second embodiment. As illustrated in FIG. 27, the image forming apparatus 3 includes a system controller 51a. As the system controller 51 described above, the system controller 51a has a computer configuration including the CPU, the SoC, the ROM, the RAM, and the like. The system controller 51a integrally controls the operation of the image forming apparatus 3. More specifically, the system controller 51a controls the image pickup direction and the focus position of the camera unit 20 according to the application being started. Because the functional configuration of the image forming apparatus 3 (system controller 51a) is the same as that of the image forming apparatus 2 (refer to FIG. 6), the description thereof will be omitted.

Hereinafter, characteristic operations of the image forming apparatus 3 according to the present embodiment will be described. A setting operation that sets the image pickup direction and the focus position of the camera unit 20 for each application will now be described.

For example, upon receiving an operation of the initial setting button B112 on the initial screen G1 described above, the system controller 51a displays an application setting screen on the display device 31, by collaborating with the UI controlling unit 103.

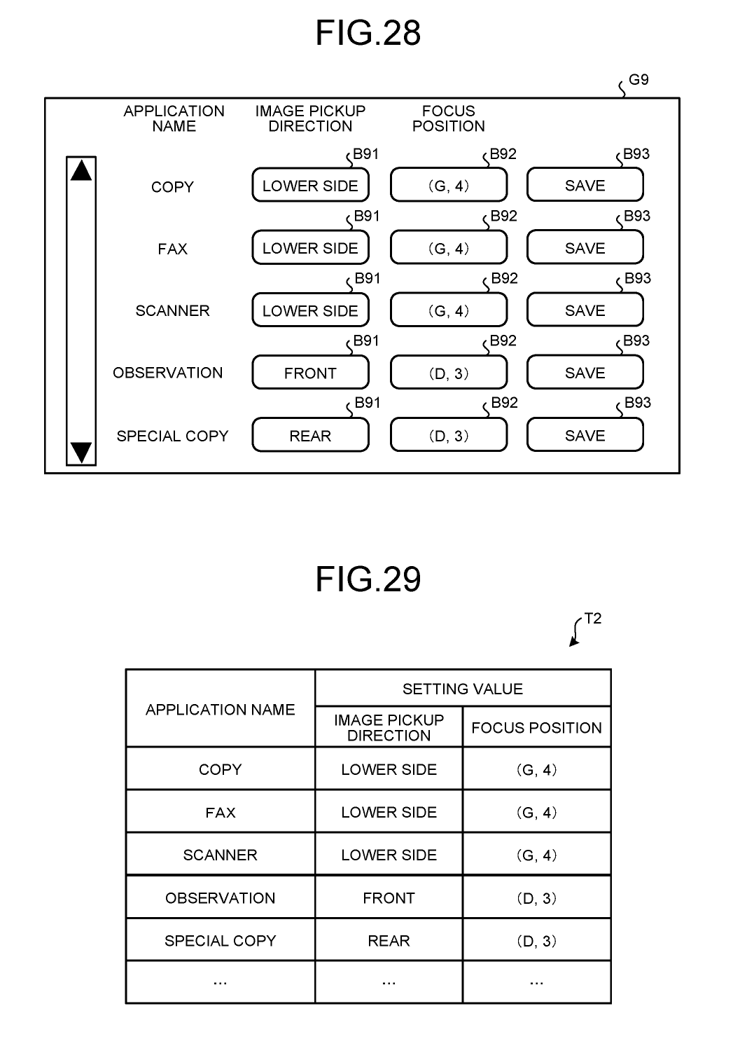

FIG. 28 is a diagram illustrating an example of an application setting screen. As illustrated in FIG. 28, an application setting screen G9 has operating elements for setting and saving the image pickup direction and the focus position of the camera unit 20, for each application (function) installed in the image forming apparatus 3, such as a copy and a scanner.

Here, an image pickup direction setting button B91 is an operating element for setting the image pickup direction of the camera unit 20. The user of the image forming apparatus 3 can specify (set) the image pickup direction of the camera unit 20, by operating the image pickup direction setting button B91. A method for specifying the image pickup direction is optional. For example, the image pickup direction setting button B91 may be operated to display a dedicated screen for specifying the image pickup direction, by displaying the image picked up by the camera unit 20 and the like. The image pickup direction setting button B91 may also be operated to specify the image pickup direction, by displaying a plurality of directions such as the vertical direction, the horizontal direction, the front direction, the rear direction, and the like, as candidates. The user may manually change the image pickup direction of the camera unit 20 after operating the image pickup direction setting button B91, and acquire the image pickup direction after the change.

A focus position setting button B92 is an operating element for setting the focus position of the camera unit 20. The user of the image forming apparatus 3 can specify (set) the focus position of the camera unit 20, by operating the focus position setting button B92. A method for specifying the focus position is optional. For example, the focus position setting button B92 may be operated to display the focus position specification screen G3 (FIG. 12) and the like described above. The focus position setting button B92 may also be operated to specify the focus position, by displaying a plurality of positions such as the upper side and the center, as candidates. It is also possible to display different document sizes as candidates. In this case, the focus position is identified from the specified document size, by using the focus position setting table T1 (FIG. 14) described above.

A save button B93 is an operating element for saving the setting value of the camera unit 20, set via the image pickup direction setting button B91 and the focus position setting button B92. More specifically, upon receiving an operation of the save button B93, the system controller 51a saves (stores) the setting value (image pickup direction and focus position) of the camera unit 20, which is set for the corresponding application, in the application setting information.

Here, FIG. 29 is a schematic diagram illustrating an example of a data configuration of application setting information. As illustrated in FIG. 29, application setting information T2 stores therein the setting values (image pickup direction and focus position) of the camera unit 20 for the application, for each application name that identifies the application, in an associated manner. For example, the application setting information T2 is retained in the storage unit 57 and the like of the image forming apparatus 3. Upon receiving an operation of the save button B93, the system controller 51a saves (updates) the setting value set via the image pickup direction setting button B91 or the focus position setting button B92, by associating it with the application name of the corresponding application.

In the application setting information T2, the image pickup direction of “lower side” and the focus position of “(G, 4)” are set for the application names of “copy”, “FAX”, and “scanner” as an example. The image pickup direction of “front” and the focus position of “(D, 3)” are set for the application name of “observation” as an example. The image pickup direction of “rear” and the focus position of “(D, 3)” are set for the application name of “special copy” as an example. Here, the coordinates of the guide image described in FIG. 10 are used to indicate the focus position. However, the description is not limited thereto.

In the application setting screen G9 in FIG. 28, the image pickup direction and the focus position can be set for each application. However, it is not limited thereto, and it is also possible to set either of the two. In the application setting screen G9 in FIG. 28, the setting value is saved according to the operation of the save button B93. However, it is not limited thereto, and the setting value set via the image pickup direction setting button B91 and the focus position setting button B92 may be directly saved in the application corresponding to the application setting information T2. It is preferable that the system controller 51a displays the current setting value saved in the application setting information T2 on the image pickup direction setting button B91 and the focus position setting button B92, upon displaying the application setting screen.

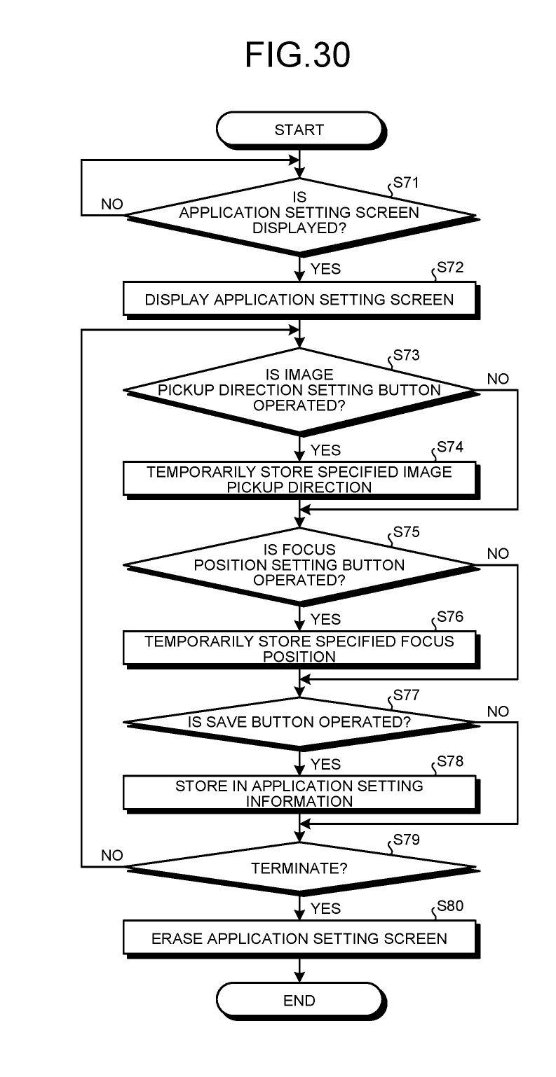

FIG. 30 is a flowchart illustrating an example of a procedure of an application setting process. The system controller 51a stands by until the initial setting button B112 or the like is operated to instruct to display the application setting screen G9 (No at step S71). If it is instructed to display the application setting screen G9 (Yes at step S71), the system controller 51a displays the application setting screen G9 on the display device 31 (step S72).

The system controller 51a then determines whether the image pickup direction setting button B91 is operated (step S73). If the image pickup direction setting button B91 is operated (Yes at step S73), the system controller 51a temporarily stores the image pickup direction specified by the user as a setting value of the corresponding application (step S74), and proceeds to step S75. If the image pickup direction setting button B91 is not operated, the system controller 51a proceeds directly to step S75.

At step S75, the system controller 51a determines whether the focus position setting button B92 is operated (step S75). If the focus position setting button B92 is operated (Yes at step S75), the system controller 51a temporarily stores the focus position specified by the user as the setting value of the corresponding application (step S76), and proceeds to step S77. If the focus position setting button B92 is not operated, the system controller 51a proceeds directly to step S77.

At step S77, the system controller 51a determines whether the save button B93 is operated (step S77). If the save button B93 is operated (Yes at step S77), the system controller 51a saves the setting value temporarily stored for the corresponding application in the application setting information T2 (step S78), and proceeds to step S79. Here, if the setting value is not temporarily stored, an error indicating that the image pickup direction and the focus position are not yet set, may be displayed. If the save button B93 is not operated, the system controller 51a proceeds directly to step S79.

At step S79, the system controller 51a determines whether the termination of the present process is instructed by the operation such as erasing the screen (step S79). Here, if the termination of the present process is not instructed (No at step S79), the system controller 51a returns to step S73. If the termination of the present process is instructed (Yes at step S79), the system controller 51a erases the application setting screen G9 (step S80), and terminates the present process.

An operation for starting an application will now be described as a characteristic operation of the image forming apparatus 3 according to the present embodiment.

When the activation (startup) of an application is instructed by the application startup operation, the system controller 51a changes the image pickup direction and the focus position of the camera unit 20, based on the setting value set for the application. More specifically, the system controller 51a reads out the setting value of the camera unit 20 corresponding to the application to be activated, from the application setting information T2, and changes the image pickup direction and the focus position of the camera unit 20 based on the setting value. With regard to the application for which there is no setting value in the application setting information T2, a default setting value (default value) determined in advance will be used.

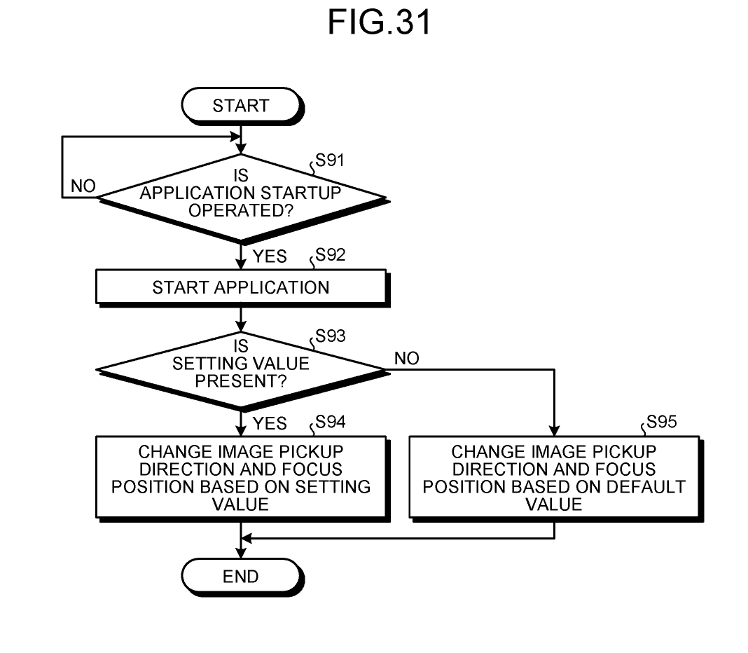

FIG. 31 is a flowchart illustrating an example of a procedure of an application startup process. The present process corresponds to steps S18 and S19 in the operation receiving process described in the first embodiment.

The system controller 51a stands by until an application startup operation for activating the application is operated (No at step S91). Upon receiving the application startup operation (Yes at step S91), the system controller 51a starts the application to be activated (step S92).

The system controller 51a then determines whether the setting value of the camera unit 20 corresponding to the application started at step S92 is saved in the application setting information T2 (step S93). If it is determined that the setting value is being saved (Yes at step S93), the system controller 51a changes the image pickup direction and the focus position of the camera unit 20 based on the setting value (step S94), and terminates the present process.

At step S93, if it is determined that the setting value is not being saved (No at step S93), the system controller 51a changes the image pickup direction and the focus position of the camera unit 20 based on the default value (step S95), and terminates the present process. This does not apply to the application that does not use the camera unit 20.

As described above, the image forming apparatus 3 according to the present embodiment saves the setting value of the camera unit 20 for each application, and when the application is started, changes the image pickup direction and the focus position of the camera unit 20, based on the setting value corresponding to the application. Thus, the image pickup direction and the focus position of the camera unit 20 can be changed automatically for each application. Consequently, it is possible to improve the convenience of the user.

The number of pieces of the application setting information T2 is not limited to one, and may be prepared for each user. In this case, the setting value of each application set by the login user is saved in the application setting information T2 for the user. Consequently, the image pickup direction and the focus position of the camera unit 20 set by each user can be reflected, when each application is started. Thus, it is possible to further improve the convenience of the user.

For example, in the embodiment described above, the present invention is applied to the image forming apparatus 2. However, it is not limited thereto. More specifically, the second characteristic of the image forming apparatus 2 may be applied to an information processing device such as a PC or a smartphone that has a communication function and a display function.

In the embodiment described above, image data is exchanged in both directions. However, it is not limited thereto. It is also possible to transmit image data only from the device of the transmission side that supplies still image data. In the embodiment described above, the camera unit 20 is also installed in the device of the reception side that receives still image data. However, it is not limited thereto, and the camera unit 20 may be omitted.

In the present embodiment, the moving image data picked up by the camera unit 20 is distributed live (live streaming). However, it is not limited thereto, and the moving image data stored in the storage unit 57 and the like may be distributed on demand.

The present invention exhibits the advantageous effect of being able to acquire still image data with higher image quality from moving image data being distributed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image data transmission device, comprising:
a first generation unit configured to generate, from first moving image data, second moving image data to be distributed;
a distribution unit configured to distribute the second moving image data generated by the first generation unit to an external device;
a first reception unit configured to receive an acquisition request for still image data from the external device, with respect to the second moving image data being distributed by the distribution unit;
a second generation unit configured to generate still image data from the first moving image data according to the acquisition request; and
a first transmission unit configured to transmit the still image data generated by the second generation unit to the external device as a response to the acquisition request.

2. The image data transmission device according to claim 1, wherein
the first reception unit receives the acquisition request including time information that indicates a specific timing, and
the second generation unit generates the still image data representing an image of the second moving image data distributed at the timing indicated by the time information, from the first moving image data.

3. The image data transmission device according to claim 1, wherein
the first reception unit receives the acquisition request including image quality information that specifies image quality, and
the second generation unit generates the still image data with the image quality specified by the image quality information, from the first moving image data.

4. The image data transmission device according to claim 1, wherein
the first reception unit receives the acquisition request including image size information that specifies an image size, and
the second generation unit generates the still image data of the image size specified by the image size information, from the first moving image data.

5. An image data reception device, comprising:
a second reception unit configured to receive, from an external device, second moving image data generated from first moving image data and distributed by the external device;
a display controlling unit configured to display the second moving image data received by the second reception unit on a display unit;
a receiving unit configured to receive an acquisition instruction of still image data with respect to the second moving image data being displayed on the display unit;
a second transmission unit configured to transmit an acquisition request for still image data to the external device, according to the acquisition instruction; and
a third reception unit configured to receive still image data generated from the first moving image data from the external device, as a response to the acquisition request.

6. The image data reception device according to claim 5, wherein
the second transmission unit transmits the acquisition request including time information that indicates a timing when the acquisition instruction is made, and
the third reception unit receives still image data representing an image of the second moving image data being displayed on the display unit when the acquisition instruction is made, from the external device, as a response to the acquisition request.

7. The image data reception device according to claim 5, further comprising:
a first specification unit configured to specify image quality of the still image data, wherein
the second transmission unit transmits the acquisition request including image quality information that indicates the image quality specified by the first specification unit, and
the third reception unit receives still image data with the image quality specified by the first specification unit, from the external device, as a response to the acquisition request.

8. The image data reception device according to claim 5, further comprising:
a second specification unit configured to specify an image size of the still image data, wherein
the second transmission unit transmits the acquisition request including image size information that indicates the image size specified by the second specification unit, and
the third reception unit receives still image data of the image size specified by the second specification unit, from the external device, as a response to the acquisition request.

9. An image data transmission and reception method performed between an image data reception transmission device and an image data reception device, the method comprising:
generating, by the image data transmission device, from first moving image data, second moving image data to be distributed;
distributing, by the image data transmission device, the generated second moving image data to the image data reception device;
receiving, by the image data reception device, the second moving image data from the image data transmission device;
displaying, by the image data reception device, the second moving image data on a display unit;
receiving, by the image data reception device, an acquisition instruction of still image data with respect to the second moving image data being displayed on the display unit;
transmitting, by the image data reception device, an acquisition request for still image data to the image data transmission device, according to the acquisition instruction;
receiving, by the image data transmission device, the acquisition request for still image data from the image data reception device, with respect to the second moving image data;
generating, by the image data transmission device, still image data from the first moving image data according to the acquisition request;
transmitting, by the image data transmission device, the generated still image data to the image data reception device as a response to the acquisition request; and
receiving, by the image data reception device, the still image data from the image data transmission device.

10. The image data transmission and reception method according to claim 9, wherein
the receiving the acquisition request from the image data reception device includes receiving the acquisition request including time information that indicates a specific timing, and
the generating the still image data includes generating the still image data representing an image of the second moving image data distributed at the timing indicated by the time information, from the first moving image data.

11. The image data transmission and reception method according to claim 9, wherein
the receiving the acquisition request from the image data reception device includes receiving the acquisition request including image quality information that specifies image quality, and
the generating the still image data includes generating the still image data with the image quality specified by the image quality information, from the first moving image data.

12. The image data transmission and reception method according to claim 9, wherein
the receiving the acquisition request from the image data reception device includes receiving the acquisition request including image size information that specifies an image size, and
the generating the still image data includes generating the still image data of the image size specified by the image size information, from the first moving image data.
